(19) United States
(12) Patent Application Publication
(10) Pub. No.: US 2026/0040148 A1
(43) Pub. Date: Feb. 5, 2026

(54) TRAFFIC ESTIMATION AND WIRELESS ACTIONS BASED ON WIRELESS TRAFFIC INGRESS RATES

(71) Applicant: QUALCOMM Incorporated, San Diego, CA (US)

(72) Inventors: John SANLI, San Francisco, CA (US); Gyanranjan HAZARIKA, Milpitas, CA (US); Sandip HOMCHAUDHURI, San Jose, CA (US)

(21) Appl. No.: 18/792,200

(22) Filed: Aug. 1, 2024

(51) Int. Cl. H04W 28/18; H04W 76/15

(52) U.S. Cl. CPC H04W 28/18; H04W 76/15

(57) ABSTRACT

This disclosure provides methods, components, devices and systems for traffic estimation and wireless actions based on wireless traffic ingress rates. Some aspects relate to traffic management techniques improve wireless communications based on ingress rates. In some examples, a wireless device may detect that a wireless communication session or a wireless node, is associated with an ingress rate that satisfies an ingress rate threshold. Based on detecting that a wireless node satisfies an ingress rate threshold, the wireless device may adjust a set of communication parameters for a wireless node. Further, based on detecting that a wireless communication session satisfies an ingress rate threshold, the wireless device may update the scheduling priority of the wireless communication session. Additionally, or alternatively, the wireless device may both adjust the set of communication parameters of a wireless node and update the scheduling priority of a wireless communication session based on the detection.

### TECHNICAL FIELD

This disclosure relates generally to wireless communication and, more specifically, to traffic estimation and wireless actions based on wireless traffic ingress rates for to wireless traffic classification and wireless traffic management.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at a wireless node is described. The method may include detecting that an ingress rate of data of a first wireless communication session associated with the wireless node satisfies an ingress rate threshold and adjusting a set of communication parameters associated with the wireless node for subsequent communications based on the ingress rate satisfying the ingress rate threshold.

Another innovative aspect of the subject matter described in this disclosure can be implemented in apparatus for wireless communication for wireless communication is described. The apparatus for wireless communication may include a processing system that includes processor circuitry and memory circuitry that stores code. The processing system may be configured to cause the apparatus for wireless communication to detect that an ingress rate of data of a first wireless communication session associated with a wireless node satisfies an ingress rate threshold and adjust a set of communication parameters associated with the wireless node for subsequent communications based on the ingress rate satisfying the ingress rate threshold.

Another innovative aspect of the subject matter described in this disclosure can be implemented in another apparatus for wireless communication for wireless communication is described. The apparatus for wireless communication may include means for detecting that an ingress rate of data of a first wireless communication session associated with a wireless node satisfies an ingress rate threshold and means for adjusting a set of communication parameters associated with the wireless node for subsequent communications based on the ingress rate satisfying the ingress rate threshold.

Another innovative aspect of the subject matter described in this disclosure can be implemented in a non-transitory computer-readable medium storing code for wireless communication is described. The code may include instructions executable by one or more processors to detect that an ingress rate of data of a first wireless communication session associated with a wireless node satisfies an ingress rate threshold and adjust a set of communication parameters associated with the wireless node for subsequent communications based on the ingress rate satisfying the ingress rate threshold.

In some examples of the method, apparatus for wireless communication, and non-transitory computer-readable medium described herein, adjusting the set of communication parameters may include operations, features, means, or instructions for moving the subsequent communications from a first wireless communication link to a second wireless communication link with a capacity higher than a capacity of the first wireless communication link.

In some examples of the method, apparatus for wireless communication, and non-transitory computer-readable medium described herein, adjusting the set of communication parameters may include operations, features, means, or instructions for allocating a set of multiple additional wireless communication links to the wireless node for the subsequent communications.

Some examples of the method, apparatus for wireless communication, and non-transitory computer-readable medium described herein may further include operations, features, means, or instructions for detecting that the ingress rate of the first wireless communication session ceases to satisfy the ingress rate threshold and adjusting the set of communication parameters of the wireless node based on the ingress rate ceasing to satisfy the ingress rate threshold.

Some examples of the method, apparatus for wireless communication, and non-transitory computer-readable medium described herein may further include operations, features, means, or instructions for updating a scheduling priority of the first wireless communication session to be different than a scheduling priority of a second wireless communication session associated with the wireless node based on the ingress rate satisfying the ingress rate threshold.

Some examples of the method, apparatus for wireless communication, and non-transitory computer-readable medium described herein may further include operations, features, means, or instructions for allocating a set of multiple additional wireless communication links to the wireless node in accordance with a multi-link operation framework.

One innovative aspect of the subject matter described in this disclosure can be implemented in a method for wireless communication at a wireless node is described. The method may include detecting that an ingress rate of data of a first wireless communication session associated with the wireless node satisfies an ingress rate threshold and updating a scheduling priority of the first wireless communication session to be different than a scheduling priority of a second wireless communication session, the update being based on the ingress rate satisfying the ingress rate threshold.

Another innovative aspect of the subject matter described in this disclosure can be implemented in an apparatus for wireless communication for wireless communication is described. The apparatus for wireless communication may include a processing system that includes processor circuitry and memory circuitry that stores code. The processing system may be configured to cause the apparatus for wireless communication to detect that an ingress rate of data of a first wireless communication session associated with a wireless node satisfies an ingress rate threshold and update a scheduling priority of the first wireless communication session to be different than a scheduling priority of a second wireless communication session, the update being based on the ingress rate satisfying the ingress rate threshold.

Another innovative aspect of the subject matter described in this disclosure can be implemented in another apparatus for wireless communication for wireless communication is described. The apparatus for wireless communication may include means for detecting that an ingress rate of data of a first wireless communication session associated with a wireless node satisfies an ingress rate threshold and means for updating a scheduling priority of the first wireless communication session to be different than a scheduling priority of a second wireless communication session, the update being based on the ingress rate satisfying the ingress rate threshold.

Another innovative aspect of the subject matter described in this disclosure can be implemented in a non-transitory computer-readable medium storing code for wireless communication is described. The code may include instructions executable by one or more processors to detect that an ingress rate of data of a first wireless communication session associated with a wireless node satisfies an ingress rate threshold and update a scheduling priority of the first wireless communication session to be different than a scheduling priority of a second wireless communication session, the update being based on the ingress rate satisfying the ingress rate threshold.

Some examples of the method, apparatus for wireless communication, and non-transitory computer-readable medium described herein may further include operations, features, means, or instructions for detecting that the ingress rate of the first wireless communication session ceases to satisfy the ingress rate threshold and updating the scheduling priority of the first wireless communication session to be different than the scheduling priority of the second wireless communication session based on the first wireless communication session ceases to satisfy the ingress rate threshold.

Some examples of the method, apparatus for wireless communication, and non-transitory computer-readable medium described herein may further include operations, features, means, or instructions for updating the scheduling priority of the first wireless communication session to be different than the scheduling priority of the second wireless communication session includes updating the scheduling priority of the first wireless communication session to be higher than the scheduling priority of the second wireless communication session.

Some examples of the method, apparatus for wireless communication, and non-transitory computer-readable medium described herein may further include operations, features, means, or instructions for updating the scheduling priority of the first wireless communication session further includes updating a scheduling priority of one or more data traffic flows associated with the first wireless communication session.

In some examples of the method, apparatus for wireless communication, and non-transitory computer-readable medium described herein, the apparatus updates the scheduling priority of the first wireless communication session in accordance with a service based scheduling framework.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example PPDU usable for communications between a wireless AP and one or more wireless STAs.

FIG. 4 shows an example of a communication traffic hierarchy that supports traffic estimation and wireless actions based on wireless traffic ingress rates.

FIG. 5 shows an example of a process diagram that supports traffic estimation and wireless actions based on wireless traffic ingress rates.

FIG. 6 shows an example of a data traffic management diagram that supports traffic estimation and wireless actions based on wireless traffic ingress rates.

FIGS. 7 and 8 show examples of a process diagram that supports traffic estimation and wireless actions based on wireless traffic ingress rates.

FIGS. 9 and 10 show block diagrams of devices that support traffic estimation and wireless actions based on wireless traffic ingress rates.

FIG. 11 shows a block diagram of an example wireless communication device that supports traffic estimation and wireless actions based on wireless traffic ingress rates.

FIG. 12 shows a diagram of a system including a device that supports traffic estimation and wireless actions based on wireless traffic ingress rates.

FIGS. 13 and 14 show block diagrams of devices that support traffic estimation and wireless actions based on wireless traffic ingress rates.

FIG. 15 shows a block diagram of an example wireless communication device that supports traffic estimation and wireless actions based on wireless traffic ingress rates.

FIG. 16 shows a diagram of a system including a device that supports traffic estimation and wireless actions based on wireless traffic ingress rates.

FIGS. 17 and 18 show process diagrams illustrating example processes performable by or at an apparatus for wireless communication, comprising: a processing system that includes processor circuitry and memory circuitry that stores code that supports traffic estimation and wireless actions based on wireless traffic ingress rates.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, wireless traffic may be classified and prioritized by latency. For example, a wireless device may be expected to have a relatively low latency and data traffic from the wireless device can be classified as low-latency traffic that should be prioritized over other types of data traffic. Therefore, wireless communication networks may be capable of classifying latency expectations of wireless traffic and prioritizing the wireless traffic accordingly. Further, in some implementations, the wireless traffic may refer to one or more data traffic flows, a wireless communication session that is associated with a set of data traffic flows, or a wireless node that is associated with a respective wireless communication session.

Various aspects relate generally to wireless traffic classification and wireless traffic management. Some aspects more specifically relate to traffic management techniques to detect and improve wireless communications associated with an ingress rate of data that satisfies an ingress rate threshold. In some examples, an access point (AP) may detect that a wireless communication session (such as a group of data traffic flow) or a wireless node (such as a wireless station (STA)) associated with one or more wireless communication sessions is associated with an ingress rate of data (e.g., a rate of receiving data) that satisfies an ingress rate threshold. For example, the AP may detect that a rate at which the AP may receive data (e.g., the ingress rate) associated with a wireless communication session is relatively higher than a rate at which data packets can be transmitted from a source to a destination.

Thus, based on the detection, the AP may perform one or more actions to assist in increasing the throughput of the wireless communication session, the wireless node, or both. For example, based on the AP detecting that a wireless node is associated with a relatively high throughput, the AP may adjust a set of communication parameters for a wireless node. For example, the AP may adjust the set of communication parameters to grant one or more additional wireless communication links to the wireless node, move the communications of a wireless node to a wireless communication link with a higher capacity (e.g., move communications from a 2.5 GHZ communication link to a 5 GHz communication link), or both. In another example, based on the AP detecting that a wireless communication session satisfies an ingress rate, the AP update the scheduling priority of communications associated with the wireless communication session over other wireless communication sessions. Additionally, or alternatively, the AP may both adjust the set of communication parameters for a wireless node and update the scheduling priority of a wireless communication session based on detecting that the wireless node, the wireless communication session, or both satisfy an ingress rate threshold.

Particular aspects of the subject matter described in this disclosure can be implemented to realize one or more of the following potential advantages. In some examples, by detecting that a wireless node, a wireless communication session, or both are associated with an ingress rate that satisfies an ingress rate threshold, the described techniques can be used to increase the throughput (e.g., the rate at which data can be transmitted from a source to a destination) of the wireless node, the wireless communication session, or both. For example, by granting one or more additional wireless communication links to a wireless node, the wireless node may be capable of spreading communications out between the various wireless communication links to reduce the buffer of communications, thus increasing the rate at which the wireless node can transmit communications to an AP (e.g., increasing the throughput associated with the wireless node). Further, by updating the scheduling priority of a wireless communication session to be higher in priority than another wireless communication session, the throughput of the wireless communication session may increase by increasing the scheduling priority of the wireless communication session. Moreover, by increasing the throughput of a wireless communication session, data traffic associated with a wireless node, or both, the described techniques may enable a more efficient and reliable wireless communications network. For example, the described techniques may increase the throughput of a wireless communication session, increase the throughput of the traffic for a wireless node (e.g., all the traffic with the wireless node as a destination), or both to be closer to the ingress rate of data of the wireless communication session, the wireless node, or both resulting in an increase in communication efficiency and reliability

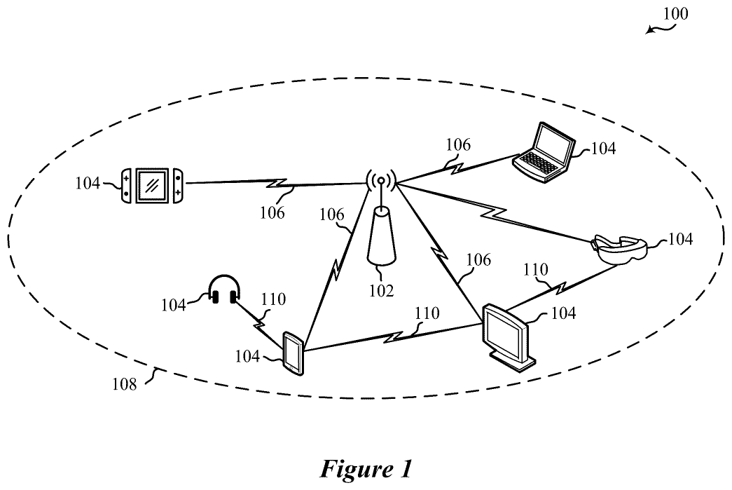

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. In some examples, a wireless node may refer to a wireless communication device, such as an AP 102 or a wireless STA 104 that communicates via the wireless network 100. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHz), FR3 (7.125 GHZ-24.25 GHZ), FR4a or FR4-1 (52.6 GHz-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHZ, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

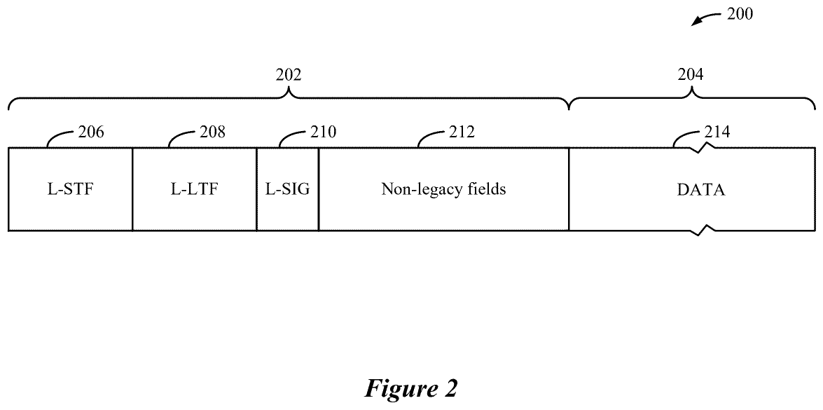

In some examples of the wireless communication network 100, in accordance with the techniques of the present disclosure, an AP 102 may detect that a wireless communication session (such as a group of data traffic flow) or a wireless node (such as a wireless STA 104) associated with one or more wireless communication sessions is associated with an ingress rate of data (e.g., a rate of receiving data) that satisfies an ingress rate threshold. For example, the AP 102 may detect that a rate at which the AP 102 may receive data (e.g., the ingress rate) associated with a wireless communication session is relatively higher than a rate at which data packets can be transmitted from a source to a destination. Thus, the techniques of the present disclosure may describe an AP 102 performing one or more actions to increase the throughput of a wireless node or a wireless communication session that satisfies an ingress rate threshold. Further descriptions of such actions may be described with reference to FIGS. 2 through 8.

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

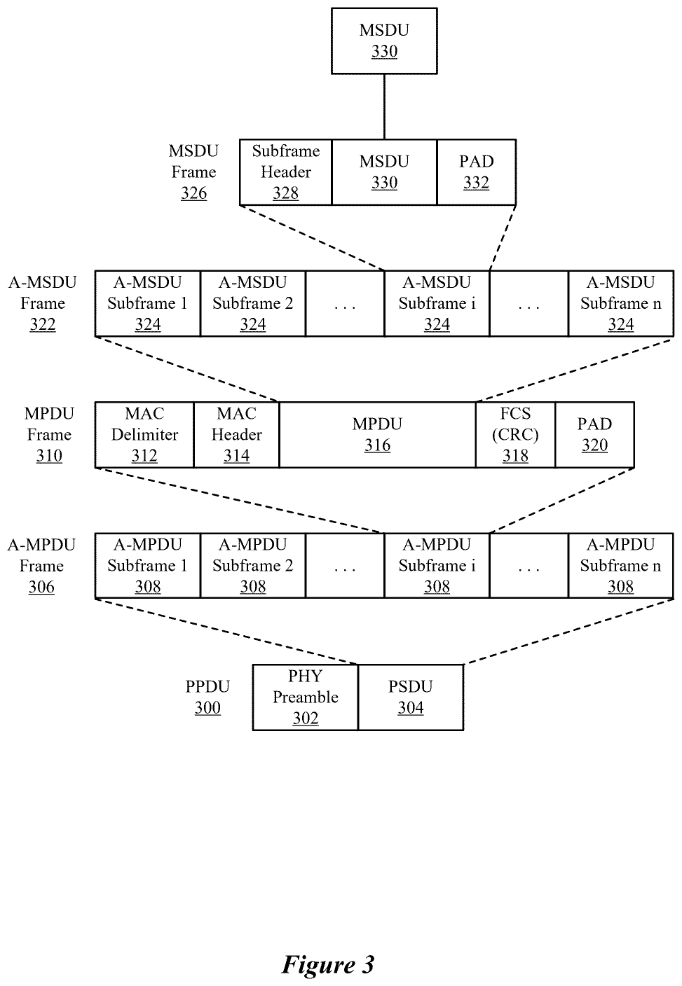

In some examples of a wireless communication network, in accordance with the techniques of the present disclosure, an AP 102 may detect that a wireless communication session (such as a group of data traffic flow) or a wireless node (such as a wireless STA 104) associated with one or more wireless communication sessions is associated with an ingress rate of data (e.g., a rate of receiving data) that satisfies an ingress rate threshold. For example, the AP 102 may detect that a rate at which the AP 102 may receive data or a PDU 200 (e.g., the ingress rate) associated with a wireless communication session is relatively higher than a rate at which data packets (e.g., a PDU 200) can be transmitted from a source to a destination. Thus, the techniques of the present disclosure may describe an AP 102 performing one or more actions to increase the throughput of a wireless node or a wireless communication session that satisfies an ingress rate threshold to improve the transmission of one or more PDUs 200. Further descriptions of such actions may be described with reference to FIGS. 3 through 8.

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHZ band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHZ band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (such as a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples, supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples, supporting distributed learning or distributed models, both APs and STAs may be independently capable of computing AI/ML models and sharing data with other participating wireless communication devices in the wireless communication network such that each device can train the global AI/ML model locally. In some examples, supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (such as some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

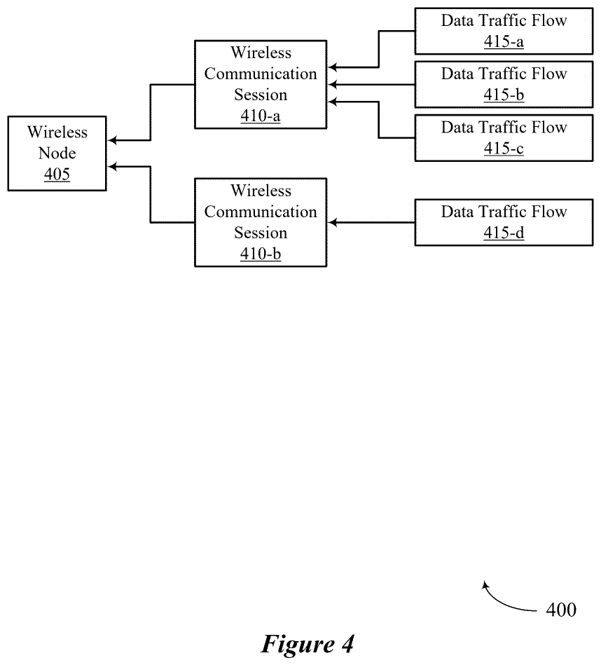

In some examples of a wireless communication network, in accordance with the techniques of the present disclosure, an AP 102 may detect, via an AI/ML model, that a wireless communication session (such as a group of data traffic flow) or a wireless node (such as a wireless STA 104) associated with one or more wireless communication sessions is associated with an ingress rate of data (e.g., a rate of receiving data) that satisfies an ingress rate threshold. For example, the AP 102 may detect that a rate at which the AP 102 may receive data or a PPDU 300 (e.g., the ingress rate) associated with a wireless communication session is relatively higher than a rate at which data packets (e.g., a PPDU 300) can be transmitted from a source to a destination. Thus, the techniques of the present disclosure may describe an AP 102 performing one or more actions to increase the throughput of a wireless node or a wireless communication session that satisfies an ingress rate threshold to improve the transmission of one or more PPDUs 300. For example, a wireless node may be a MLD and to increase the throughput of the wireless node, the AP 102 may grant additional wireless communication links, move communications to a higher capacity wireless communication link, or both. In another example, the AP 102 may prioritize and schedule communications associated with the wireless communication session over other wireless communication sessions to increase the throughput of a respective wireless communication session. Further descriptions of such actions may be described with reference to FIGS. 4 through 8.

FIG. 4 shows an example of a communication traffic hierarchy 400 that supports traffic estimation and wireless actions based on wireless traffic ingress rates. The communication traffic hierarchy 400 may implement or be implemented to realize one or more aspects of the wireless communication network 100. For example, the communication traffic hierarchy 400 may represent the communications between an AP 102 and a STA 104 as described with reference to FIG. 1.

In some examples, a wireless node 405 (such as a STA 104) may communicate with a respective wireless devices (such as APs 102) or other services. A wireless node 605 may refer to a wireless communication device, such as an AP 102 or a STA 104 that communicates via the wireless communication network 100. In some examples, the wireless node 405 may communicate with another wireless device via a wireless communication session 410 (such as a wireless communication session 410-a, a wireless communication session 410-b, or both). Moreover, a respective wireless communication session 410 may be associated with one or more data traffic flows 415 (such as a data traffic flow 415-a, a data traffic flow 415-b, a data traffic flow 415-c, a data traffic flow 415-d, or any combination of thereof).

In some implementations, a respective data traffic flow 415 may indicate a flow of data packets that are associated with the same parameters. For example, a data traffic flow 415 may be representative of a set of data packets that have the same source internet protocol (IP) address, destination IP address, source port, destination port, communication protocol, source MAC address, and destination MAC address. For example, the data traffic flow 415-a and the data traffic flow 415-b may be associated with a set of data packets that are associated with voice data (e.g., voice over internet protocol (VOIP) transmissions) and the data traffic flow 415-c may be associated with a set of data packets that includes video data.

In some examples, the respective data traffic flows 415 (such as the data traffic flow 415-a, the data traffic flow 415-b, and the data traffic flow 415-c) may be used together for the same wireless communication session 410. For example, the wireless communication session 410-a may be a video conferencing session of a video conferencing application or service that uses voice data and video data that are associated with the same source and destination IP address. Thus, a respective wireless communication session 410 may be representative of a group of data traffic flows 415 that share the same source IP address and the same destination IP address. Moreover, a respective wireless communication session 410 may indicate the set of data traffic flows 415 that are being transmitted across different ports and protocols. Further, the wireless node 405 may be associated with the same destination MAC address as the wireless communication session 410-a and the wireless communication session 410-b. In some examples, the wireless node 405 may be referred to as a parent to the wireless communication session 410-a and the wireless communication session 410-b in the communication traffic hierarchy 400.

In some implementations, the communication traffic hierarchy 400 may indicate a hierarchal structure of communications within a wireless communications network. For example, the communication traffic hierarchy 400 may indicate that a wireless node 405 can be associated with various different respective wireless communication sessions 410 that are associated with various data traffic flows 415.

In some examples, in accordance with the techniques of the present disclosure, the wireless node 405, a respective wireless communication session 410, or a respective data traffic flows 415 may be associated with an ingress rate that satisfies an ingress rate threshold. For example, in some implementations, a traffic classifier of the wireless communication network may use an AI/ML model and AI/ML techniques to classify one or more data traffic types as having relatively low latency expectations. Thus, by using the techniques of the present disclosure, a traffic classifier can detect that the wireless node 405, a respective wireless communication session 410, or a respective data traffic flows 415 are associated with an ingress rate that satisfies an ingress rate threshold.

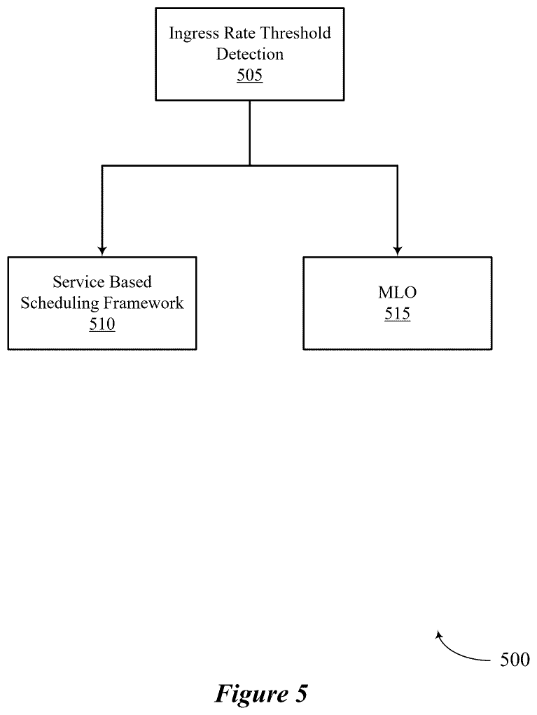

Further descriptions of the communication traffic hierarchy 400 and detecting that a respective wireless communication session 410 or a wireless node 405 is associated with an ingress rate that satisfies an ingress rate threshold may be described elsewhere herein. For example, detecting that a respective wireless communication session 410 or a wireless node 405 is associated with a an ingress rate that satisfies an ingress rate threshold and enhancing the performance of the respective wireless communication session 410, the wireless node 405, or both to increase the throughput and increase the reliability of communications may be described elsewhere herein, such as with reference to FIGS. 5-8.

FIG. 5 shows an example of a process diagram 500 that supports traffic estimation and wireless actions based on wireless traffic ingress rates. The process diagram 500 may implement or be implemented to realize one or more aspects of the wireless communication network 100. For example, the process diagram 500 may illustrate an AP 102 detecting an ingress rate threshold being satisfied in a service based scheduling frameworks and multi-link operation (MLO) frameworks.

In some examples, as described elsewhere herein, a wireless device (such as an AP 102) may perform ingress rate threshold detection 505 to classify a wireless communication session or a wireless node as satisfying an ingress rate threshold. Such detection may enable the wireless device to obtain an input to prioritize and schedule data traffic for a wireless communication session that satisfies an ingress rate threshold in a service based scheduling framework 510, an input to adjust communication parameters for a wireless node that satisfies an ingress rate threshold in an MLO framework 515, or both.

For example, in the service based scheduling framework 510 framework, a throughput-based service level agreement (SLA) may be assigned to a wireless communication session based on the throughput of respective wireless communication sessions. Further, throughput of data traffic may be measured based on traffic volume per a unit of time. For example, throughput of data traffic may be measured in bytes per minutes or megabits per second. Thus, using the SLA, a wireless device may be capable of ensuring accurate and reliable scheduling prioritization of wireless communication sessions within the service based scheduling framework 510. Moreover, the addition of the ingress rate threshold detection 505 to the service based scheduling framework 510 may enable a wireless communications network to support throughput-based SLAs. An SLA may represent an agreement with a wireless communications service provider that indicated various performance parameters for a wireless communications network. For example, an SLA may indicate various performance parameter thresholds that the wireless communications network is expected to satisfy. In some implementations, as the techniques of the present disclosure enables ingress rate threshold detection 505 for wireless communication sessions, the wireless communication network may be capable of having a throughput performance parameter threshold within an SLA.

In another example, in the MLO framework 515, wireless devices may be capable of enhancing the allocation of band-related resources by using client-based inputs including ingress throughput and high throughput distribution. For example, if a wireless node in the MLO framework 515 is associated with an ingress rate that is detected via the ingress rate threshold detection 505, a wireless device may allocate (e.g., grant) additional resources to the wireless node. By receiving the additional resources, the wireless node may be capable of establishing additional wireless communication links to distribute communications and thus increase the throughput of traffic originating from or destined to the wireless node (e.g., increase a rate at which data is being transmitted to a wireless node, from a wireless node, or both).

In some examples, if a wireless node is associated with two wireless communication sessions (such as two communication sessions have the same the destination MAC address) and a single wireless communication link, the ingress rate threshold detection 505 may determine that the wireless node satisfies an ingress rate threshold. For example, a second wireless communication session may experience a high level of latency due to the wireless node using the single wireless communication link for a first wireless communication session, thus resulting in a high traffic volume at the wireless node. Traffic volume may refer to a portion of traffic at a wireless node that is associated with a respective resource. For example, a wireless node may have a high traffic volume for a respective single or set of wireless communication link(s). Moreover, a wireless node with a single wireless communication link may experience a relatively high traffic volume for the wireless communication link due to the wireless node satisfying an ingress rate threshold. Therefore, in accordance with the techniques of the present disclosure, based on the ingress rate threshold detection 505, a wireless device may be capable of allocating additional wireless communication resources, wireless communication links, or both to the wireless node to increase the throughput of the wireless node. For example, if the wireless node is allocated an additional wireless communication link, the wireless node may be capable of allocating a first wireless communication session to a first wireless communication link and a second wireless communication session to a second wireless communication link thus reducing the latency of communications and increasing the throughput of the wireless node.

In some examples, a kernel (e.g., a kernel of an operating system such as Linux) database and/or a wireless router using the database may be used to track the wireless nodes, wireless communication sessions, and data traffic flows in a wireless communication network. For example, the database may track a total transmitted and received packets and bytes per connection (such as per wireless node or per wireless communication session). Additionally, or alternatively, the total bytes, ingress rates, throughput, and throughput delta (such as rate of change of throughput) may be tracked in both the ingress and egress directions for each respective connection. For example, as shown in the communication traffic hierarchy 400 illustrated in FIG. 4, communications can be represented in a tree-structured database with parent-child relationships and the communications in both the transmission and reception directions can be tracked and stored. Thus, both the transmissions and receptions of a data traffic flow associated with a wireless communication session from a wireless node may be tracked and stored.

Further, statistics from each traffic classifier within a wireless communication network may be collected and the statistics and flow information can be aggregated within a database to perform the ingress rate threshold detection 505 for wireless traffic. Additionally, or alternatively, the statistics may be periodically shared within a user space. Moreover, a throughput monitor that is a user space application may implement the database to collect and store information for performing the ingress rate threshold detection 505 in the service based scheduling framework 510, the MLO framework 515, or both.

In some implementations, the data processing for the database may be divided into two parts, database population and database cleanup. For the database population, the database may iterate through all the connection database flows and perform dynamic allocation of data from wireless nodes, wireless communication sessions, and data traffic flows. Moreover, the database may calculate the statistics for respective data traffic flows. When populating the database, when data associated with a data traffic flow is received, the database may first check if the other data associated with the data traffic flow exists in the database and if so, the database will update the data for the respective data traffic flow accordingly. Otherwise, the database may check if a wireless communication session that is associated with the data traffic flow exists in the database and if so, a data traffic flow entry may be entered into the database and updated based on the received data. If a wireless communication session that is associated with the data traffic flow does not exist, the database may check if a wireless node associated with the data traffic flow exits in the database. If so, the database may create a wireless communication session entry, a data traffic flow entry, and update the data traffic flow entry accordingly. Otherwise, the database may create a wireless node entry, a wireless communication session entry, a data traffic flow entry, and update the data traffic flow entry with the received data accordingly.

For aggregating and cleaning up the database, a wireless device may perform an iterative process to clean the database and aggregate information. For example, for a respective wireless node the wireless device may check if there are any wireless communication sessions remaining to check. If there are not any wireless communication sessions to check (such as there are no remaining child wireless communication sessions for a parent wireless node) the wireless device may free the wireless node instance and move to the next wireless node in the database. If there is a remaining wireless communication session for a respective wireless node, the wireless device may check each child data traffic flow until the wireless device checks each data traffic flow associated with the parent wireless communication session. The wireless device may further determine if a respective data traffic flow instance was updated in the population phase. If the respective data traffic flow instance was updated, the wireless device may aggregate the statistics across the parent wireless communication session instance, otherwise, the wireless device may go to the next data traffic flow instance of the patent wireless communication session. If there are any remaining child data traffic flow instances for a parent wireless communication session, the statistics of the wireless communication session may be aggregated across the parent wireless node, otherwise, the wireless device may move to the next wireless communication session of the parent wireless node. Therefore, by performing such iterative procedure, a wireless device may be capable of aggregating data traffic flow statistics into wireless communication session and wireless node statistics. Moreover, the wireless device may be capable of freeing data traffic flow, wireless communication session, and wireless node instances in the database.

Using the aggregated database, a resource manager (such as a user space application) may implement one or more quality of experience (QoE) algorithms for a scheduler of the service based scheduling framework 510 based on SLA parameters or to handle band provisioning in the MLO framework 515. For example, the resource manager of a wireless device may perform link provisioning to adjust a set of communication parameters for a wireless node (such as grant additional wireless communication links, move communications to a wireless communication link with a relatively higher capacity, or both) in the MLO framework 515 or perform wireless communication session scheduling via ingress rate SLA scheduling in the service based scheduling framework 510. Moreover, a wireless device may be capable of performing the ingress rate threshold detection 505 by using the database to mark or indicate that a respective wireless communication session or parent wireless node satisfies an ingress rate threshold.

In some implementations, the ingress rate threshold detection 505 may detect whether a wireless communication session satisfies an ingress rate value threshold or an ingress rate delta threshold, whether a wireless node satisfies an ingress rate value threshold or an ingress rate delta threshold, or both. If a respective wireless communication session or a parent wireless node satisfy either the ingress rate value threshold or the ingress rate delta threshold, the ingress rate threshold detection 505 may detect that the wireless communication session, the wireless node, or both satisfy an ingress rate threshold and a detection algorithm detection can be triggered.

In some examples, since most high throughput wireless traffic can have some ramp up time, the wireless device may perform the ingress rate threshold detection 505 using the ingress rate delta thresholds to enable the wireless device the capability of performing the ingress rate threshold detection 505 relatively faster. For example, a wireless device may receive traffic information at an interval of one second and after one second the ingress rate of a wireless communication session or a wireless node may be 1 Gbps and after two seconds the ingress rate of the wireless communication session or the wireless node may be 3 Gbps. Using this information, if the wireless device uses an ingress rate value threshold of 3 Gbps, the wireless device node may detect that the wireless communication session or the wireless node satisfies the ingress rate value threshold after two seconds. However, if the wireless device uses an ingress rate delta threshold (such as a rate of change of a rate of change threshold) of 1 Gbps, the wireless device may detect that the wireless communication session or the wireless node satisfies the ingress rate delta threshold and is after one second, thus performing the ingress rate threshold detection 505 with less latency. For example, after the first second, the wireless device may determine that the ingress rate of data of the wireless communication session or the wireless node is increasing at a rate of 1 Gbps and thus the ingress rate threshold detection 505 can be triggered earlier than a value based threshold.

Moreover, to aid with resource management, once a wireless communication session or a wireless node no longer satisfies an ingress rate threshold, a wireless device should disassociate links from a wireless node, move communications to a wireless link with a different capacity, deprioritize wireless communication sessions, or any combination thereof. In some implementations, for a wireless communication session or wireless node to be detected as no longer satisfying an ingress rate threshold, the wireless communication session or the wireless node may have to refrain from satisfying both the ingress rate value thresholds and the ingress rate delta thresholds. For example, a wireless communication session may be detected to no longer be satisfying an ingress rate threshold after the wireless communication session refrains from satisfying an ingress rate value threshold and an ingress rate delta threshold, and after a parent wireless node refrains from satisfying an ingress rate value threshold and an ingress rate delta threshold.

In some implementations, a wireless node and a child wireless communication session may have the same ingress rate value thresholds and ingress rate delta thresholds. In some other implementations, the ingress rate threshold detection 505 may be based on a first ingress rate value threshold and a first ingress rate delta threshold that are associated with the wireless node and on a second ingress rate value threshold and a second ingress rate delta threshold that are associated with a wireless communication session. In some examples, based on the ingress rate threshold detection 505 detecting that a wireless node or that a wireless communication session refrains from satisfying an ingress rate threshold, one or more QoE algorithms may be triggered to deallocate resources or to perform a de-prioritization procedure. Additionally, or alternatively, if each connection of a respective wireless communication session are flushed from the database, the wireless device may initiate the one or more QoE algorithms to clean up any remaining high ingress rate associated data within the database.

In some examples, due to inconsistent or aperiodic traffic patterns, temporary ingress rate drops, or changes in wireless traffic, a wireless node or a wireless communication session may refrain from satisfying the ingress rate thresholds for a short period of time. Thus, if traffic is constantly being detected as satisfying an ingress rate threshold and refraining from satisfying an ingress rate threshold, a wireless device may waste resources by constantly changing the QoE parameters. Moreover, continuously updating resource allocations and priorities may be relatively time consuming and may increase latency of communications within a wireless communication network. Therefore, in some implementations, the techniques of the present disclosure may describe that a wireless device should deallocate resources (such as adjust communication parameters) or update scheduling priority after a wireless node or that a wireless communication session refrains from satisfying any of the ingress rate thresholds for a threshold quantity of time. For example, the wireless device may wait until the wireless node or the wireless communication session refrains from satisfying any of the ingress rate thresholds for x intervals. As such, these techniques may make use of hysteresis concepts to avoid erratic and jittery behavior in response to operating near a threshold. Moreover, assuming an ingress rate value threshold of 3 Gbps and a threshold quantity of time being 3 intervals, a wireless device may refrain from deallocating resources or updating priorities until an ingress rate of a wireless node or a wireless communication session is below 3 Gbps for at least 3 intervals.

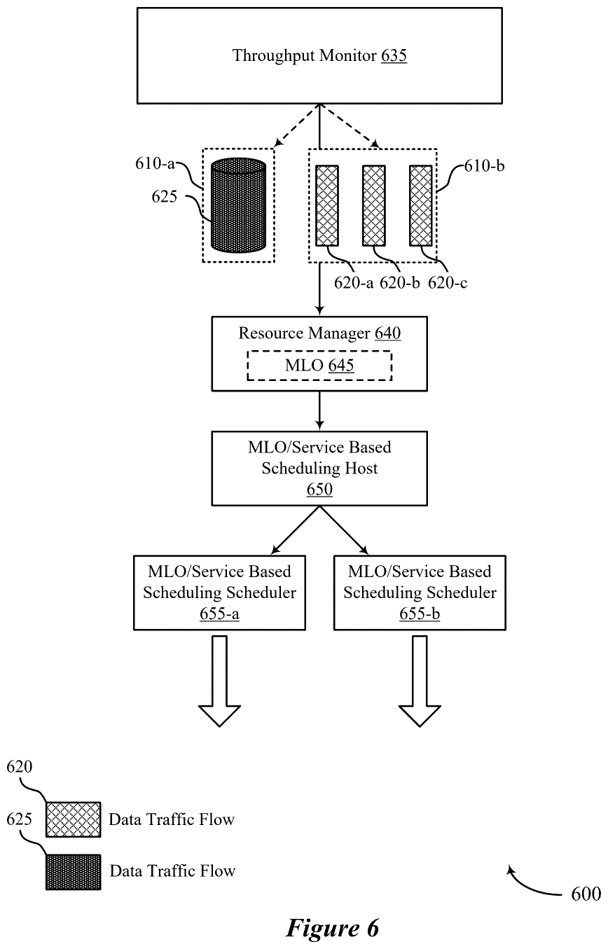

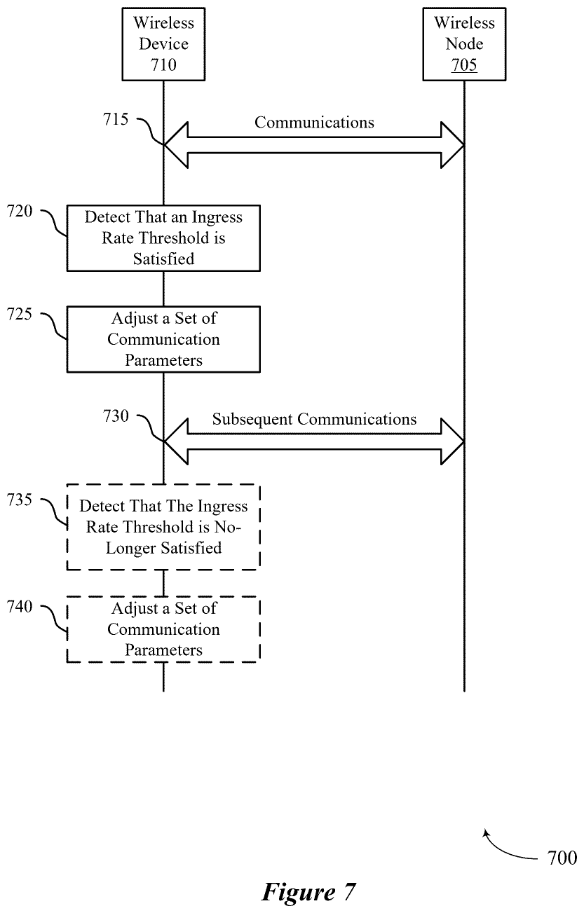

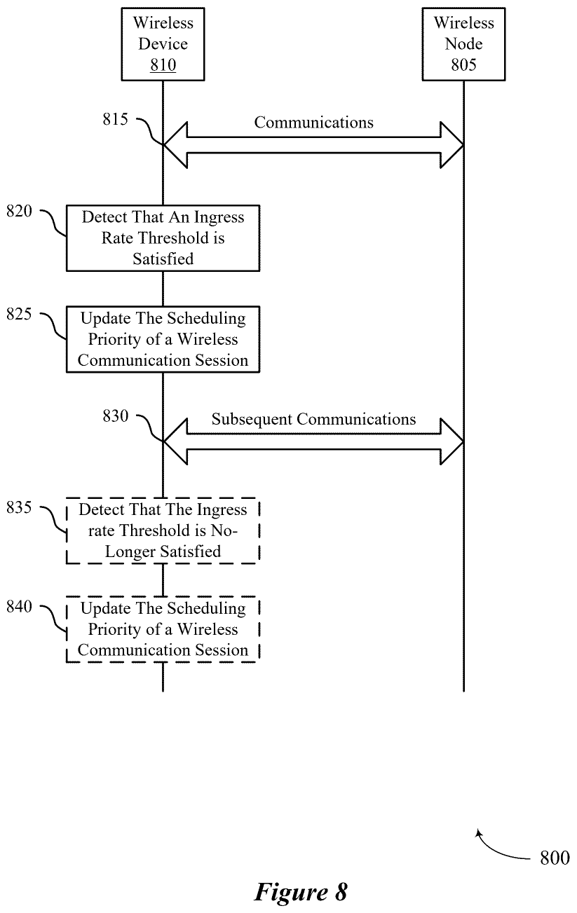

Further descriptions of the techniques of the present disclosure may be described elsewhere herein, such as with reference to FIGS. 6-8. For example, FIGS. 6 and 7 may describe a wireless device performing the ingress rate threshold detection 505 in the MLO framework 515 where to improve and increase the throughput of data traffic with a wireless node as the destination, the wireless device may adjust a set of communication parameters of wireless node. Moreover, FIGS. 6 and 8 may describe a wireless device performing the ingress rate threshold detection 505 in the service based scheduling framework 510 where to improve and increase the throughput of a respective wireless communication session the wireless node may change the priority of the respective wireless communication session to be higher in priority than other wireless communication sessions. Additionally, or alternatively, FIG. 6 may describe a wireless device both adjusting a set of communication parameters for a wireless node and updating the priority of a respective wireless communication session in response to the ingress rate threshold detection 505.

FIG. 6 shows an example of a data traffic management diagram 600 that supports traffic estimation and wireless actions based on wireless traffic ingress rates. The data traffic management diagram 600 may implement or be implemented to realize one or more aspects of the wireless communication network 100. For example, the data traffic management diagram 600 may represent the communications between an AP 102 and a STA 104 as described with reference to FIG. 1. Further, the data traffic management diagram 600 may implement the communication traffic hierarchy 400, the process diagram 500, or both.

In some examples, a wireless communication network may have wireless clients communicate with wireless devices (such as an AP 102). In some cases, a wireless client may be associated with one or more data traffic flows (e.g., a data traffic flow 620-a, a data traffic flow 620-b, a data traffic flow 620-c, and a data traffic flow 625). Further, as described elsewhere herein, a set of data traffic flows may be associated with a respective wireless communication session 610 (e.g., a wireless communication session 610-a and a wireless communication session 610-b) that is associated with a respective wireless node.

In some implementations, a throughput monitor 635 at a wireless device may detect the ingress rate of the various data traffic flows in the various wireless communication sessions 610 from the various wireless nodes. Further, the throughput monitor 635 may classify data traffic flows, wireless communication sessions 610, or wireless nodes as satisfying an ingress rate threshold. In some cases, the throughput monitor 635 may be associated with a traffic classifier that is used to classify data traffic flows. For example, a traffic classifier may classify one or more data traffic flows 620 (e.g., a data traffic flow 620-a, a data traffic flow 620-b, and a data traffic flow 620-c). as being associated with respective latency expectations. In some examples, the traffic classifier may be implemented or may implement one or more AI/ML techniques to classify such data traffic. Further, the traffic classifier may be used in a wireless network in addition to the throughput monitor 635 to classify data traffic flows in addition to monitoring the throughput of data traffic. Therefore, in some implementations, a wireless network may use both the throughput monitor 635 to monitor throughput of data traffic for detecting satisfaction of ingress rate thresholds and a traffic classifier to classify data traffic in the wireless network.

Thus, the throughput monitor 635 may determine that the wireless communication session 610-a or a wireless node associated with the wireless communication session 610-a satisfies at least one ingress rate threshold as described elsewhere herein, such as with reference to FIG. 5. In some implementations, the throughput monitor 635 may be a periodic throughput database that stores the ingress rates of wireless nodes and associated wireless communication sessions 610. Using the stored ingress rates, a wireless device may be capable of using the throughput monitor 635 to determine if a respective wireless node, a respective wireless communication session 610 associated with a wireless node, or both, satisfy an ingress rate threshold (such as an ingress rate value threshold or an ingress rate delta threshold) or may be latency sensitive traffic. For example, a traffic classifier as described herein may use AI/ML techniques for latency classifications to classify data traffic as latency sensitive traffic.

Once the throughput monitor 635 determines that a respective wireless node or a respective wireless communication session 610 satisfies an ingress rate threshold, a wireless device may implement a resource manager 640 in the data traffic management diagram 600. For example, a wireless device may use the resource manager 640 to adjust a set of communication parameters of a wireless node via an MLO component 645 or update scheduling priority of a wireless communication session 610. In some implementations, the MLO component 645 may be a part of the resource manager 640 or a component that communicates with the resource manager 640. Using the MLO component 645, the resource manager 640 may be capable of ensuring channel bonding for an MLO client (such as a wireless node 605) with a conservative single link bond all the way to all the links in a multi-link multi-radio (MLMR) mode based on a set of criteria. For example, the MLO component 645 may ensure that a wireless node satisfies a latency SLA threshold, a throughput SLA threshold or a combination thereof, and a wireless communication session 610 satisfies a limited interference threshold, a limited traffic load threshold, or both.

In some implementations, since the wireless communication session 610-a may be associated with the data traffic flow 625 that satisfies an ingress rate threshold, the wireless node associated with the wireless communication session 610-a satisfy an ingress rate threshold that indicates that the ingress rate of the wireless node is relatively higher than the throughput of the wireless node. Thus, the techniques of the present disclosure may enable the MLO component 645 of the resource manager 640 to enhance one or more MLO algorithms to result in a channel-bonding configuration for a respective wireless node that satisfies an ingress rate threshold. Moreover, the MLO component 645 may refrain from impacting the QoE of the wireless node 605-a. For example, a wireless node may initially be configured with a single link for a respective wireless communication session 610. In some implementations, as a respective wireless node 605 may refrain from satisfying an ingress rate threshold, the resource manager 640 may allow the respective wireless node to continue to operate with a single wireless communication link. In some other implementations, another respective wireless node may satisfy the ingress rate threshold, the resource manager 640 may utilize the MLO component 645 to adjust a set of communication parameters for the respective wireless node.

In some examples, the adjustment of the set of communication parameters may include the MLO component 645 granting (such as allocating, extending an allowance, adding, or any combination thereof) a wireless node with a set of additional wireless communication links. For example, by granting a wireless node with the set of additional wireless communication links, the wireless node may be capable of spreading the communications of the wireless communication session 610-a and the data traffic flow 625 that satisfy an ingress rate threshold across multiple wireless communication links, resulting in an increase in throughput. In some other examples, the adjustment of the set of communication parameters may include the MLO component 645 moving the communications on a first wireless communication link to a second wireless communication link with a different capacity. For example, communications may be moved from a 2.4 GHz link to a 5 GHz link based on an offered load (e.g., a measure of traffic relative to the channel capacity). Additionally, or alternatively, the adjustment of the set of communication parameters may include the MLO component 645 both granting a wireless node a set of additional wireless communication links and moving communications to wireless communication links with a different (e.g., higher) capacity.

Further, in a service based scheduling framework (such as a framework for flow classification and prioritization), the resource manager 640 may update the scheduling priority of a respective wireless communication session 610 to be different than another wireless communication session 610. In some cases, updating the scheduling priority may be associated with updating the priority of communications being scheduled via various wireless LAN scheduling algorithms. Moreover, in some implementations, in the service based scheduling framework, the resource manager 640 may assist in resource allocation and resource management in the framework. For example, based on the resource manager 640 determining (that the wireless communication session 610-a satisfies an ingress rate threshold, the resource manager 640 may update the scheduling priority of the wireless communication session 610-a and the wireless communication session 610-b. In some implementations, the resource manager 640 may update the scheduling priority of the wireless communication session 610-a to be higher than the scheduling priority of the wireless communication session 610-b based on the wireless communication session 610-a satisfying the ingress rate threshold. That is, communications associated with the wireless communication session 610-a (such as the data traffic flow 625) may be scheduled before communications associated with the wireless communication session 610-b (such as the data traffic flows 220). Further, the resource manager 640 may update the scheduling priority of the wireless communication session 610-a to be lower than the scheduling priority of the wireless communication session 610-b based on the wireless communication session 610-a satisfying the ingress rate threshold. For example, the resource manager 640 may update scheduling of the communications associated with the wireless communication session 610-a to be scheduled after the communications associated with the wireless communication session 610-b.

Once the resource manager 640 determines whether a respective wireless node, a respective wireless communication session 610, or both, satisfies an ingress rate threshold, a host 650 may forward the indication to a respective scheduler 655. For example, the host 650 may forward an indication of the adjustments to the set of communication parameters of a first wireless node an indication of the update in scheduling priority of the wireless communication session 610-a, or both to a scheduler 655-a that is associated with a first wireless node 605. Moreover, the host 650 may forward indications related to a second wireless node and the wireless communication session 610-b to a schedule 655-b that is associated with the second wireless node.

In the service based scheduling framework, the scheduler 655 may be used to prioritize the respective wireless communication sessions 610 according to a programmed SLA. Additionally, or alternatively, a respective scheduler 655 may be used to prioritize respective data traffic flows. Further, the prioritization may be based on and relative to the SLA for the respective wireless communication sessions 610 or wireless nodes. Moreover, when the wireless communication session 610-a is classified as being satisfying an ingress rate threshold, the scheduler 655-a may prioritize the scheduling of data traffic flows of the wireless communication session 610-a (such as the data traffic flow 625) accordingly. For example, the scheduler 655-a may prioritize data traffic flows that may satisfy an ingress rate threshold such as speed tests or file transfers. Therefore, the techniques of the present disclosure may enable respective schedulers 655 to provide prioritized treatment to wireless communication sessions 610 and respective data traffic flows that satisfy an ingress rate threshold.

Additionally, or alternatively, the techniques of the present disclosure may use the throughput monitor 635, the resource manager 640, and the respective schedulers 655 to provide enhance channel-bonding and flow-prioritization for a wireless node in a wireless network by combining the techniques of the MLO framework and the service based scheduling framework. Moreover, such techniques of implementing both the MLO framework and the service based scheduling framework may result in an enhanced QoE which can lead to increasing throughput, reduced latency, and an increase in efficiency, reliability, and accuracy of communications in a wireless network. Further techniques of the present disclosure may be described elsewhere herein, such as with reference to FIGS. 7 and 8.

FIG. 7 shows an example of a process diagram 700 that supports traffic estimation and wireless actions based on wireless traffic ingress rates. In some examples, the process diagram 700 may implement or be implemented by the wireless communication network 100, the communication traffic hierarchy 400, the process diagram 500, the data traffic management diagram 600, or any combination thereof. For example, the process diagram 700 may include a wireless node 705 and a wireless device 710, which may be examples of devices described herein with reference to FIGS. 1-3.

In the following description of the process diagram 700, the operations between the wireless node 705 and the wireless device 710 may be performed in different orders or at different times. Some operations also may be left out of the process diagram 700, or other operations may be added. Although the wireless node 705 and the wireless device 710 are shown performing the operations of the process diagram 700, some aspects of some operations also may be performed by one or more other wireless devices.

At 715, the wireless node 705 and the wireless device 710 may communicate via one or more wireless communication sessions that are associated with one or more data traffic flows as described with reference to FIGS. 4 and 6. At 720, the wireless device 710 may detect that an ingress rate of data associated with a first wireless communication session of the wireless node 705 satisfies an ingress rate threshold. In some examples, the first wireless communication session may include one or more data traffic flows that share a source IP address and a destination IP address. Further, the one or more data traffic flows may be associated with at least one of the source IP address, the destination IP address, a source port, a destination port, a communication protocol, a source MAC address, or a destination MAC address. The first wireless communication session may be associated with at least one of the source IP address or the destination IP address, and the wireless node 705 may be associated with the destination MAC address. In some examples, the wireless device 710 may detect that the first wireless communication session satisfies at least one of a first ingress rate value threshold associated with the wireless node 705, a first ingress rate delta threshold associated with the wireless node 705, a second ingress rate value threshold associated with the first wireless communication session, or a second ingress rate delta threshold associated with the first wireless communication session. Additionally, or alternatively, the wireless device 710 may include at least one of a periodic ingress rate database, a set of quality algorithms, a host, or a scheduler, which are configured to detect that the first wireless communication session satisfies the ingress rate threshold. In some other cases, the wireless node 705 may include at least one transceiver configured to detect that the first wireless communication session satisfies the ingress rate threshold. In some other examples, the wireless device 710 may be an AP.

At 725, the wireless device 710 may adjust a set of communication parameters of the wireless node 705 for subsequent communications at 730 based on detecting that the first wireless communication session satisfies the ingress rate threshold. In some examples, the wireless device 710 may move communications from a first wireless communication link associated with a first capacity to a second wireless communication link associated with a second capacity for the subsequent communications based on the ingress rate of the first wireless communication session satisfying the ingress rate threshold. In some other examples, the wireless device 710 may grant a set of additional wireless communication links to the wireless node 705 for the subsequent communications based on the ingress rate of the first wireless communication session satisfying the ingress rate threshold. Additionally, or alternatively, the wireless device 710 may adjust the set of communication parameters of the wireless node 705 in accordance with a multi-link operation framework.

In some examples, the wireless device 710 may update, in addition to adjusting the set of communication parameters of the wireless node 705, a scheduling priority of the first wireless communication session to be different than a priority of a second wireless communication session of the wireless node 705 based on detecting that the first wireless communication session satisfies the ingress rate threshold.

At 735, the wireless device 710 may detect that the ingress rate of the first wireless communication session ceases from satisfying the ingress rate threshold. In some examples, the wireless device 710 may detect that the first wireless communication session ceases from satisfying the ingress rate threshold for a set of time intervals. At 740, the wireless device 710 may adjust the set of communication parameters of the wireless node 705 based on detecting that the first wireless communication session ceases from satisfying the ingress rate threshold.

FIG. 8 shows an example of a process diagram 800 that supports traffic estimation and wireless actions based on wireless traffic ingress rates. In some examples, the process diagram 800 may implement or be implemented by the wireless communication network 100, the communication traffic hierarchy 400, the process diagram 500, the data traffic management diagram 600, or any combination thereof. For example, the process diagram 800 may include a wireless node 805 and a wireless device 810, which may be examples of devices described herein with reference to FIGS. 1-3.

In the following description of the process diagram 800, the operations between the wireless node 805 and the wireless device 810 may be performed in different orders or at different times. Some operations also may be left out of the process diagram 800, or other operations may be added. Although the wireless node 805 and the wireless device 810 are shown performing the operations of the process diagram 800, some aspects of some operations also may be performed by one or more other wireless devices.

At 815, the wireless node 805 and the wireless device 810 may communicate via one or more wireless communication sessions that are associated with one or more data traffic flows as described with reference to FIGS. 4 and 6. At 820, the wireless device 810 may detect that an ingress rate of data of a first wireless communication session associated with a wireless node 805 satisfies an ingress rate threshold. In some examples, the wireless device 810 may detect that the first wireless communication session satisfies at least one of a first ingress rate value threshold associated with the wireless node 805, a first ingress rate delta threshold associated with the wireless node 805, a second ingress rate value threshold associated with the first wireless communication session, or a second ingress rate delta threshold associated with the first wireless communication session. In some other examples, the wireless device 810 may detect that the ingress rate of the wireless node 805 satisfies the ingress rate threshold. Additionally, or alternatively, the wireless device 810 may include at least one of an ingress rate manager, a throughput monitor, a resource manager, a host, or a scheduler, which are configured to detect that the first wireless communication session satisfies the ingress rate threshold. In some other cases, the wireless device 810 may include at least one transceiver configured to detect that the first wireless communication session satisfies the ingress rate threshold. In some other examples, the wireless device 810 may be an AP.

At 825, the wireless device 810 may update a scheduling priority of the first wireless communication session to be different than a scheduling priority of a second wireless communication session between the wireless device 810 and the wireless node 805 based on detecting that the first wireless communication session satisfies the ingress rate threshold for subsequent communications at 830. In some examples, updating the scheduling priority of the first wireless communication session may include updating the scheduling priority of the first wireless communication session to be higher in priority or lower in priority than the scheduling priority of the second wireless communication session. In some other examples, updating the scheduling priority of the first wireless communication session may include updating a scheduling priority of one or more data traffic flows associated with the first wireless communication session. In some examples, the one or more data traffic flows may share a source IP address and a destination IP address. In some other cases, the one or more data traffic flows may be associated with at least one of the source IP address, the destination IP address, a source port, a destination port, a communication protocol, a source MAC address, or a destination MAC address, the first wireless communication session may be associated with at least one of the source IP address and the destination IP address, and the wireless node 805 may be associated with the destination MAC address. Additionally, or alternatively, the wireless device 810 may update the scheduling priority of the first wireless communication session in accordance with a service based scheduling framework.

At 835, the wireless device 810 may detect that the ingress rate of the first wireless communication session ceases from satisfying the ingress rate threshold. In some examples, the wireless device 810 may detect that the first wireless communication session ceases from satisfying the ingress rate threshold for a set of time intervals. At 840, the wireless device 810 may update the scheduling priority of the first wireless communication session to be different than the scheduling priority of the second wireless communication session based on detecting that the first wireless communication session ceases from satisfying the ingress rate threshold.

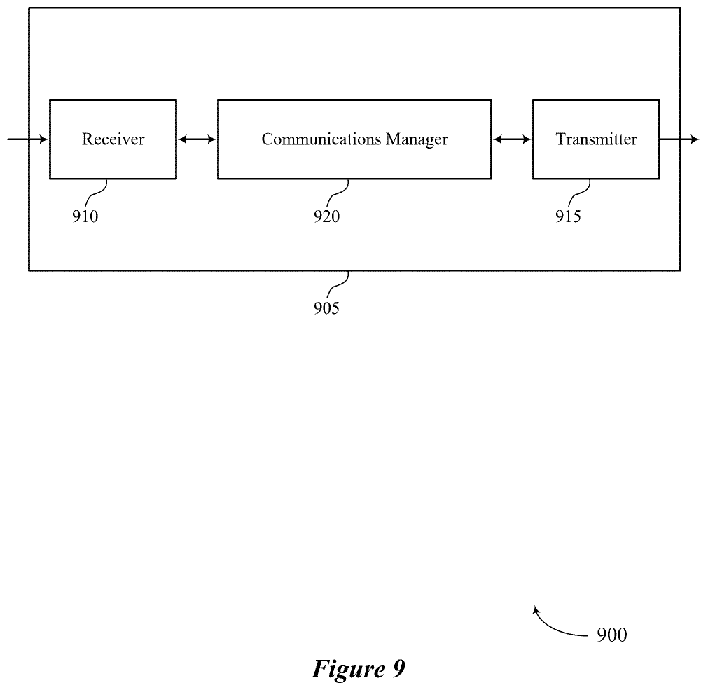

FIG. 9 shows a block diagram 900 of a device 905 that supports traffic estimation and wireless actions based on wireless traffic ingress rates in accordance with one or more aspects of the present disclosure. The device 905 may be an example of aspects of an AP as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to traffic estimation and wireless actions based on wireless traffic ingress rates). Information may be passed on to other components of the device 905. The receiver 910 may utilize a single antenna or a set of multiple antennas.

The transmitter 915 may provide a means for transmitting signals generated by other components of the device 905. The transmitter 915 may utilize a single antenna or a set of multiple antennas.

The communications manager 920, the receiver 910, the transmitter 915, or various combinations or components thereof may be examples of means for performing various aspects of traffic estimation and wireless actions based on wireless traffic ingress rates as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 is capable of, configured to, or operable to support a means for detecting that an ingress rate of data of a first wireless communication session associated with a wireless node satisfies an ingress rate threshold. The communications manager 920 is capable of, configured to, or operable to support a means for adjusting a set of communication parameters associated with the wireless node for subsequent communications based on the ingress rate satisfying the ingress rate threshold.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reducing the throughput of a wireless node, a wireless communication session, or both to support reduced processing, reduced power consumption, and more efficient utilization of communication resources.

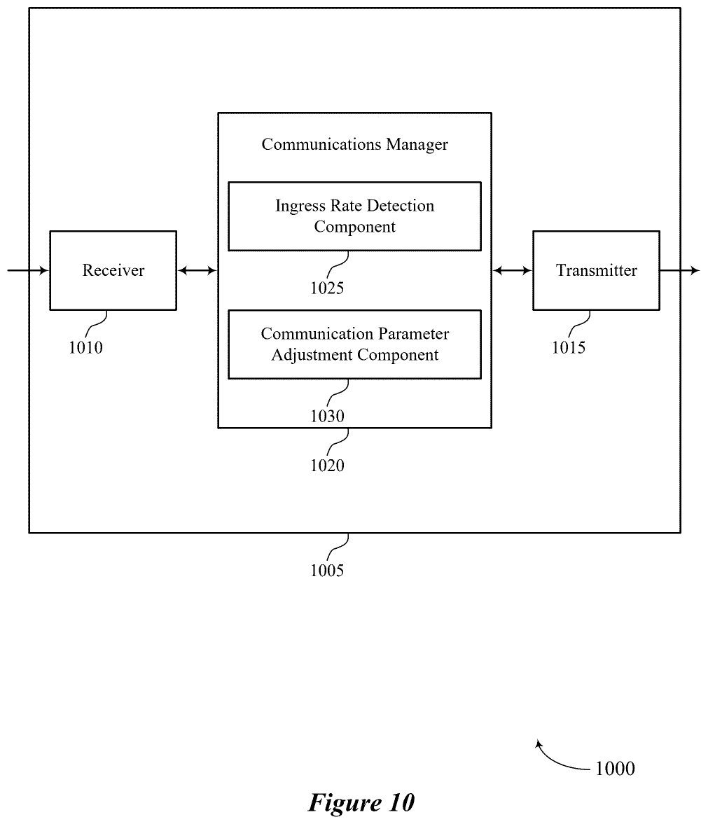

FIG. 10 shows a block diagram 1000 of a device 1005 that supports traffic estimation and wireless actions based on wireless traffic ingress rates in accordance with one or more aspects of the present disclosure. The device 1005 may be an example of aspects of a device 905 or an AP 115 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to traffic estimation and wireless actions based on wireless traffic ingress rates). Information may be passed on to other components of the device 1005. The receiver 1010 may utilize a single antenna or a set of multiple antennas.

The transmitter 1015 may provide a means for transmitting signals generated by other components of the device 1005. The transmitter 1015 may utilize a single antenna or a set of multiple antennas.

The device 1005, or various components thereof, may be an example of means for performing various aspects of traffic estimation and wireless actions based on wireless traffic ingress rates as described herein. For example, the communications manager 1020 may include an ingress rate detection component 1025 a communication parameter adjustment component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The ingress rate detection component 1025 is capable of, configured to, or operable to support a means for detecting that an ingress rate of data of a first wireless communication session associated with a wireless node satisfies an ingress rate threshold. The communication parameter adjustment component 1030 is capable of, configured to, or operable to support a means for adjusting a set of communication parameters associated with the wireless node for subsequent communications based on the ingress rate satisfying the ingress rate threshold.

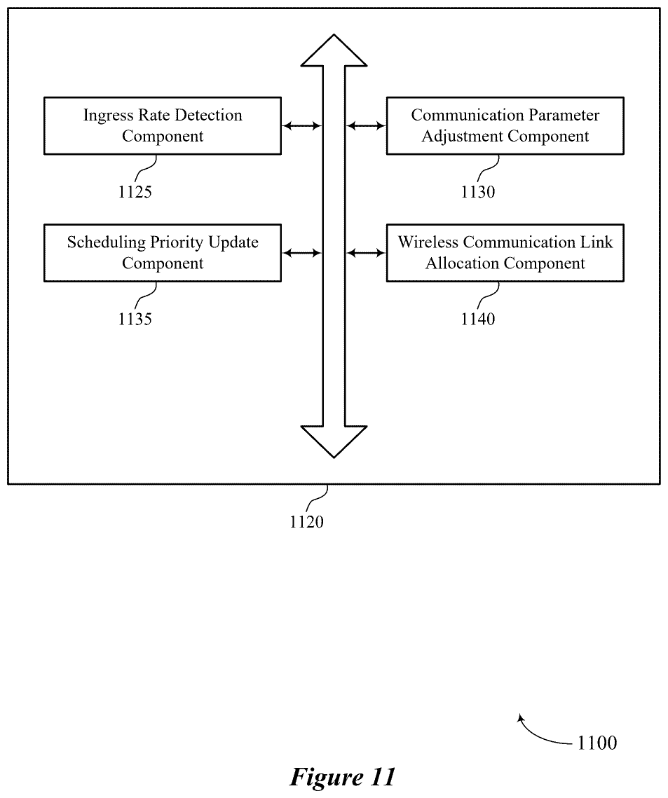

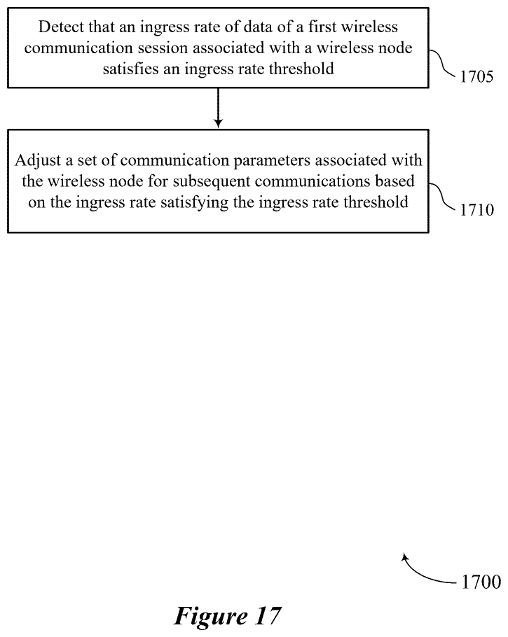

FIG. 11 shows a block diagram of an example wireless communication device 1100 that supports traffic estimation and wireless actions based on wireless traffic ingress rates. In some examples, the wireless communication device 1100 is configured to perform the process 1700 described with reference to FIG. 17. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

Further, various components of the wireless communication device 1100 may provide means for performing the methods described herein. In some examples, means for transmitting and/or receiving may include the transceivers and/or antenna(s) of the wireless communication device 1100. In some examples, means for outputting or sending (such as means for outputting for transmission) and means for obtaining (such as means for obtaining after information is received from a different device) may include one or more interfaces of the wireless communication device 1100 to output signals to other components or obtain signals from other components of the wireless communication device 1100. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for detecting, means for adjusting, means for moving, means for allocating, and/or means for updating, include a processing system, processor circuitry (including one or more processors), memory circuitry, and/or computer-readable media of the wireless communication device 1100.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in a communications manager, such as the AP 102 or the STA 104 described with reference to FIG. 1. In some other examples, the wireless communication device 1100 can be a communications manager that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes a user interface (UI) (such as a touchscreen or keypad) and a display, which may be integrated with the UI to form a touchscreen display that is coupled with the processing system. In some examples, the wireless communication device 1100 may further include one or more sensors such as, for example, one or more inertial sensors, accelerometers, temperature sensors, pressure sensors, or altitude sensors, that are coupled with the processing system. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes an ingress rate detection component 1125, a communication parameter adjustment component 1130, a scheduling priority update component 1135, and a wireless communication link allocation component 1140. Portions of one or more of the ingress rate detection component 1125, the communication parameter adjustment component 1130, the scheduling priority update component 1135, and the wireless communication link allocation component 1140 may be implemented at least in part in hardware or firmware. For example, one or more of the ingress rate detection component 1125, the communication parameter adjustment component 1130, the scheduling priority update component 1135, and the wireless communication link allocation component 1140 may be implemented at least in part by at least a processor or a modem. In some examples, portions of one or more of the ingress rate detection component 1125, the communication parameter adjustment component 1130, the scheduling priority update component 1135, and the wireless communication link allocation component 1140 may be implemented at least in part by a processor and software in the form of processor-executable code stored in memory.

The wireless communication device 1100 may support wireless communication in accordance with examples as disclosed herein. The ingress rate detection component 1125 is configurable or configured to detect that an ingress rate of data of a first wireless communication session associated with a wireless node satisfies an ingress rate threshold. The communication parameter adjustment component 1130 is configurable or configured to adjust a set of communication parameters associated with the wireless node for subsequent communications based on the ingress rate satisfying the ingress rate threshold.

In some examples, to support adjusting the set of communication parameters, the communication parameter adjustment component 1130 is configurable or configured to move the subsequent communications from a first wireless communication link to a second wireless communication link with a capacity higher than a capacity of the first wireless communication link.

In some examples, to support adjusting the set of communication parameters, the communication parameter adjustment component 1130 is configurable or configured to allocate a set of multiple additional wireless communication links to the wireless node for the subsequent communications.

In some examples, to support detecting that the ingress rate of data satisfies the ingress rate threshold, the ingress rate detection component 1125 is configurable or configured to detect that the first wireless communication session satisfies at least one of a first ingress rate value threshold associated with the wireless node, a first ingress rate delta threshold associated with the wireless node, a second ingress rate value threshold associated with the first wireless communication session, or a second ingress rate delta threshold associated with the first wireless communication session.

In some examples, the ingress rate detection component 1125 is configurable or configured to detect that the ingress rate of the first wireless communication session ceases to satisfy the ingress rate threshold. In some examples, the communication parameter adjustment component 1130 is configurable or configured to adjust the set of communication parameters of the wireless node based on the ingress rate ceasing to satisfy the ingress rate threshold.

In some examples, the ingress rate detection component 1125 is configurable or configured to detect that the ingress rate ceases from satisfying the ingress rate threshold for each time interval of a set of multiple time intervals.

In some examples, the scheduling priority update component 1135 is configurable or configured to update a scheduling priority of the first wireless communication session to be different than a scheduling priority of a second wireless communication session associated with the wireless node based on the ingress rate satisfying the ingress rate threshold.

In some examples, at least one of the adjustment or the update is based on one or more of a set of multiple procedures associated with the detection.

In some examples, the first wireless communication session includes one or more data traffic flows, each data traffic flow being associated with a same source internet protocol (IP) address and a same destination IP address.

In some examples, the one or more data traffic flows are further associated with at least one of a source port, a destination port, a communication protocol, a source medium access control (MAC) address, or a destination MAC address. In some examples, the wireless node is associated with the destination MAC address.

In some examples, the wireless communication link allocation component 1140 is configurable or configured to allocate a set of multiple additional wireless communication links to the wireless node in accordance with a multi-link operation framework.

In some examples, the detection is based on at least one of a periodic ingress rate database, a set of quality algorithms, a host, or a scheduler.

In some examples, the apparatus further includes one or more antennas configured to communicate with the wireless node via the set of communication parameters. In some examples, the apparatus configured as an access point (AP).

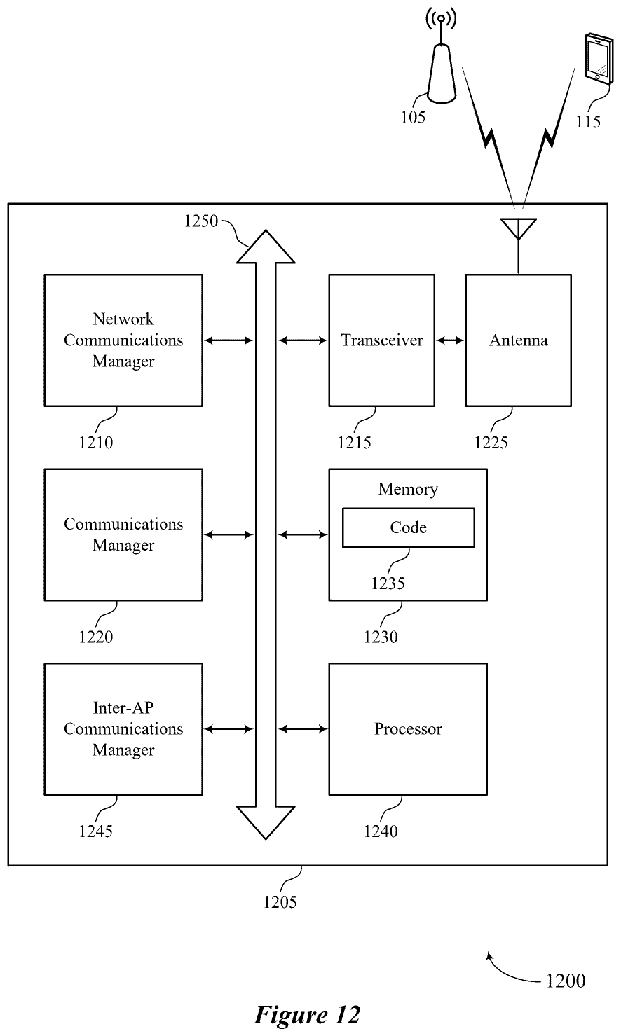

FIG. 12 shows a diagram of a system 1200 including a device 1205 that supports traffic estimation and wireless actions based on wireless traffic ingress rates in accordance with one or more aspects of the present disclosure. The device 1205 may be an example of or include components of a device 905, a device 1005, or an AP as described herein. The device 1205 may include components for bi-directional voice and data communications including components for transmitting and receiving communications, such as a communications manager 1220, a network communications manager 1210, a transceiver 1215, one or more antennas 1225, at least one memory 1230, code 1235, at least one processor 1240, and an inter-AP communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network (e.g., via one or more wired backhaul links). For example, the network communications manager 1210 may manage the transfer of data communications for client devices, such as one or more STAs 115.

In some cases, the device 1205 may include a single antenna. However, in some other cases the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets and provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable, or processor-executable code, such as code 1235. The code 1235 may include instructions that, when executed by the processor 1240, cause the device 1205 to perform various functions described herein. In some cases, the memory 1230 may include, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting traffic estimation and wireless actions based on wireless traffic ingress rates). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other APs 105, and may include a controller or scheduler for controlling communications with STAs 115 in cooperation with other APs 105. For example, the inter-station communications manager 1245 may coordinate scheduling for transmissions to APs 105 for various interference mitigation techniques such as beamforming or joint transmission. In some examples, the inter-station communications manager 1245 may provide an X2 interface within an LTE/LTE-A wireless communication network technology to provide communication between APs 105.

The communications manager 1220 may support wireless communication in accordance with examples as disclosed herein. For example, the communications manager 1220 is capable of, configured to, or operable to support a means for detecting that an ingress rate of data of a first wireless communication session associated with a wireless node satisfies an ingress rate threshold. The communications manager 1220 is capable of, configured to, or operable to support a means for adjusting a set of communication parameters associated with the wireless node for subsequent communications based on the ingress rate satisfying the ingress rate threshold.

By including or configuring the communications manager 1220 in accordance with examples as described herein, the device 1205 may support techniques for may support techniques for reducing the throughput of a wireless node, a wireless communication session, or both to support improved communication reliability, reduced latency, improved user experience related to reduced processing, reduced power consumption, more efficient utilization of communication resources, improved coordination between devices, longer battery life, and improved utilization of processing capability.

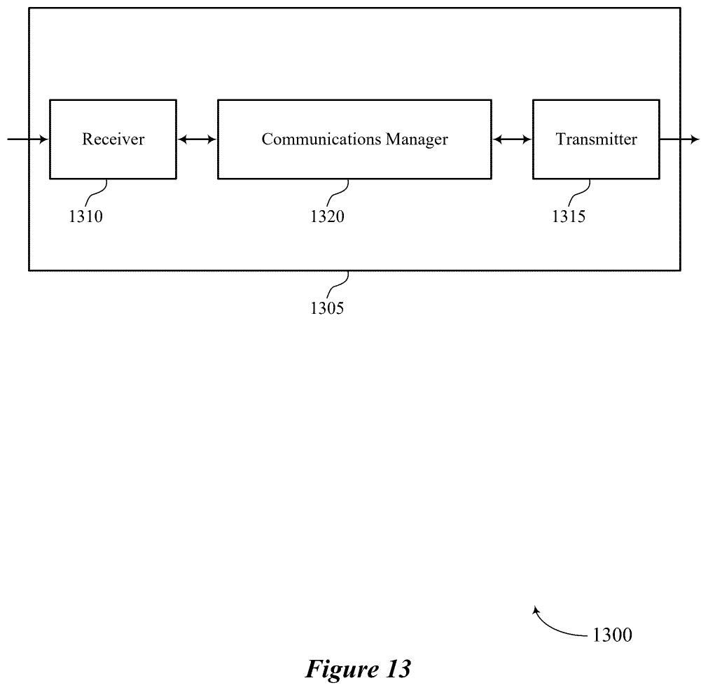

FIG. 13 shows a block diagram 1300 of a device 1305 that supports traffic estimation and wireless actions based on wireless traffic ingress rates in accordance with one or more aspects of the present disclosure. The device 1305 may be an example of aspects of an AP as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to traffic estimation and wireless actions based on wireless traffic ingress rates). Information may be passed on to other components of the device 1305. The receiver 1310 may utilize a single antenna or a set of multiple antennas.

The transmitter 1315 may provide a means for transmitting signals generated by other components of the device 1305. The transmitter 1315 may utilize a single antenna or a set of multiple antennas.

The communications manager 1320, the receiver 1310, the transmitter 1315, or various combinations or components thereof may be examples of means for performing various aspects of traffic estimation and wireless actions based on wireless traffic ingress rates as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication in accordance with examples as disclosed herein. For example, the communications manager 1320 is capable of, configured to, or operable to support a means for detecting that an ingress rate of data of a first wireless communication session associated with a wireless node satisfies an ingress rate threshold. The communications manager 1320 is capable of, configured to, or operable to support a means for updating a scheduling priority of the first wireless communication session to be different than a scheduling priority of a second wireless communication session, the update being based on the ingress rate satisfying the ingress rate threshold.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reducing the throughput of a wireless node, a wireless communication session, or both to support reduced processing, reduced power consumption, and more efficient utilization of communication resources.

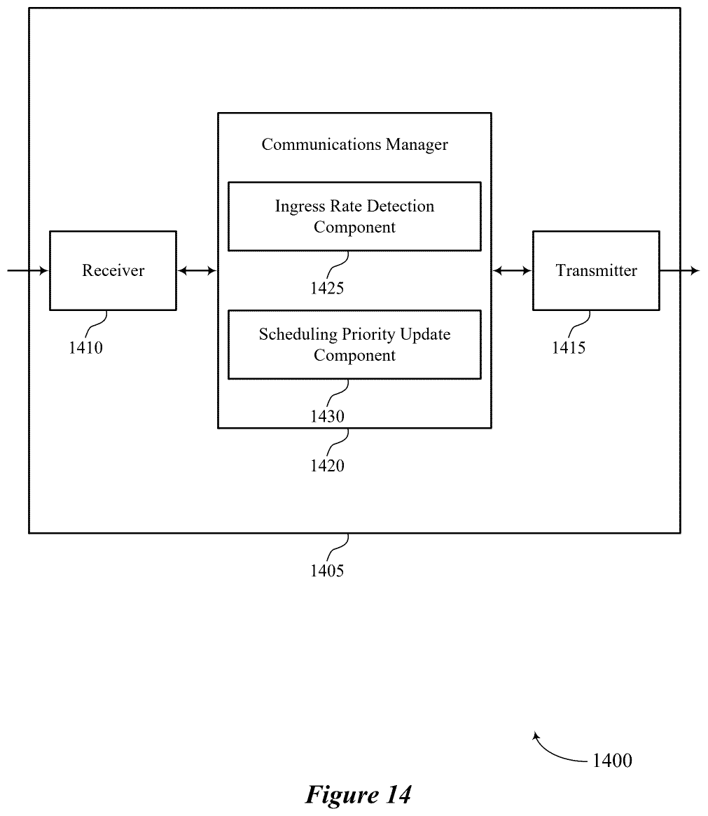

FIG. 14 shows a block diagram 1400 of a device 1405 that supports traffic estimation and wireless actions based on wireless traffic ingress rates in accordance with one or more aspects of the present disclosure. The device 1405 may be an example of aspects of a device 1305 or an AP 115 as described herein. The device 1405 may include a receiver 1410, a transmitter 1415, and a communications manager 1420. The device 1405, or one of more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for receiving information such as packets, user data, control information, or any combination thereof associated with various information channels (e.g., control channels, data channels, information channels related to traffic estimation and wireless actions based on wireless traffic ingress rates). Information may be passed on to other components of the device 1405. The receiver 1410 may utilize a single antenna or a set of multiple antennas.

The transmitter 1415 may provide a means for transmitting signals generated by other components of the device 1405. The transmitter 1415 may utilize a single antenna or a set of multiple antennas.

The device 1405, or various components thereof, may be an example of means for performing various aspects of traffic estimation and wireless actions based on wireless traffic ingress rates as described herein. For example, the communications manager 1420 may include an ingress rate detection component 1425 a scheduling priority update component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication in accordance with examples as disclosed herein. The ingress rate detection component 1425 is capable of, configured to, or operable to support a means for detecting that an ingress rate of data of a first wireless communication session associated with a wireless node satisfies an ingress rate threshold. The scheduling priority update component 1430 is capable of, configured to, or operable to support a means for updating a scheduling priority of the first wireless communication session to be different than a scheduling priority of a second wireless communication session, the update being based on the ingress rate satisfying the ingress rate threshold.

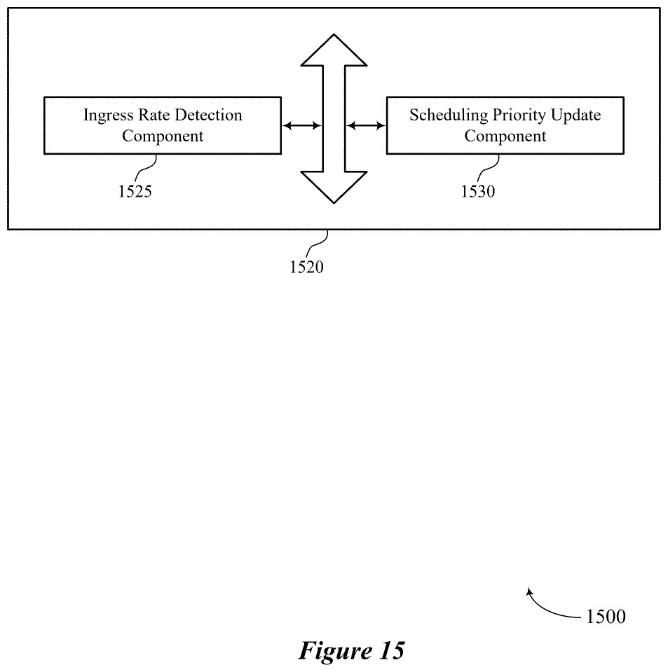

FIG. 15 shows a block diagram 1500 of a communications manager 1520 that supports traffic estimation and wireless actions based on wireless traffic ingress rates in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of traffic estimation and wireless actions based on wireless traffic ingress rates as described herein. For example, the communications manager 1520 may include an ingress rate detection component 1525 a scheduling priority update component 1530, or any combination thereof. Each of these components, or components or subcomponents thereof (e.g., one or more processors, one or more memories), may communicate, directly or indirectly, with one another (e.g., via one or more buses).

Further, various components of the wireless communication device 1500 may provide means for performing the methods described herein. In some examples, means for transmitting and/or receiving may include the transceivers and/or antenna(s) of the wireless communication device 1500. In some examples, means for outputting or sending (such as means for outputting for transmission) and means for obtaining (such as means for obtaining after information is received from a different device) may include one or more interfaces of the wireless communication device 1500 to output signals to other components or obtain signals from other components of the wireless communication device 1500. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for detecting, means for adjusting, means for moving, means for allocating, and/or means for updating, include a processing system, processor circuitry (including one or more processors), memory circuitry, and/or computer-readable media of the wireless communication device 1500.

The wireless communication device 1500 may support wireless communication in accordance with examples as disclosed herein. The ingress rate detection component 1525 is configurable or configured to detect that an ingress rate of data of a first wireless communication session associated with a wireless node satisfies an ingress rate threshold. The scheduling priority update component 1530 is configurable or configured to update a scheduling priority of the first wireless communication session to be different than a scheduling priority of a second wireless communication session, the update being based on the ingress rate satisfying the ingress rate threshold.

In some examples, the ingress rate detection component 1525 is configurable or configured to detect that the first wireless communication session satisfies at least one of a first ingress rate value threshold associated with the wireless node, a first ingress rate delta threshold associated with the wireless node, a second ingress rate value threshold associated with the first wireless communication session, or a second ingress rate delta threshold associated with the first wireless communication session.

In some examples, the ingress rate detection component 1525 is configurable or configured to detect that the ingress rate of the first wireless communication session ceases to satisfy the ingress rate threshold. In some examples, the scheduling priority update component 1530 is configurable or configured to update the scheduling priority of the first wireless communication session to be different than the scheduling priority of the second wireless communication session based on the first wireless communication session ceases to satisfy the ingress rate threshold.

In some examples, detect that the ingress rate ceases to satisfy the ingress rate threshold for each time interval of a set of multiple time interval.

In some examples, updating the scheduling priority of the first wireless communication session to be different than the scheduling priority of the second wireless communication session includes updating the scheduling priority of the first wireless communication session to be higher than the scheduling priority of the second wireless communication session.

In some examples, updating the scheduling priority of the first wireless communication session further includes updating a scheduling priority of one or more data traffic flows associated with the first wireless communication session.

In some examples, the apparatus updates the scheduling priority of the first wireless communication session in accordance with a service based scheduling framework.

In some examples, the apparatus further includes one or more antennas configured to communicate with the wireless node according to the scheduling priority. In some examples, the apparatus is configured as an access point (AP).

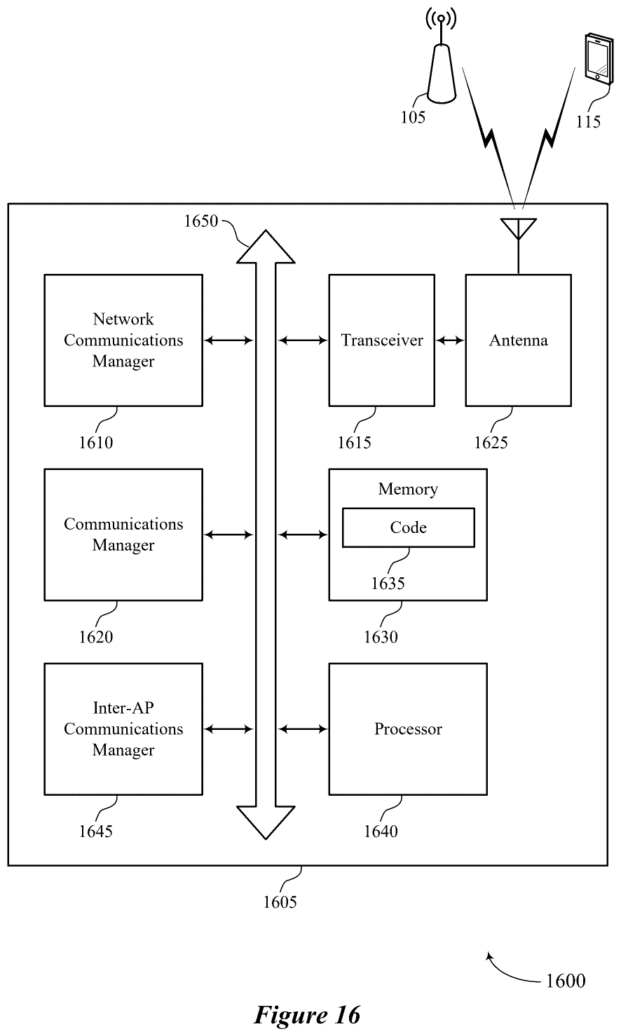

FIG. 16 shows a diagram of a system 1600 including a device 1605 that supports traffic estimation and wireless actions based on wireless traffic ingress rates in accordance with one or more aspects of the present disclosure. The device 1605 may be an example of or include components of a device 1305, a device 1405, or an AP as described herein. The device 1605 may include components for bi-directional voice and data communications including components for transmitting and receiving communications, such as a communications manager 1620, a network communications manager 1610, a transceiver 1615, one or more antennas 1625, at least one memory 1630, code 1635, at least one processor 1640, and an inter-AP communications manager 1645. These components may be in electronic communication or otherwise coupled (e.g., operatively, communicatively, functionally, electronically, electrically) via one or more buses (e.g., a bus 1650).

The network communications manager 1610 may manage communications with a core network (e.g., via one or more wired backhaul links). For example, the network communications manager 1610 may manage the transfer of data communications for client devices, such as one or more STAs 115.

In some cases, the device 1605 may include a single antenna. However, in some other cases the device 1605 may have more than one antenna, which may be capable of concurrently transmitting or receiving multiple wireless transmissions. The transceiver 1615 may communicate bi-directionally via the one or more antennas 1625 using wired or wireless links as described herein. For example, the transceiver 1615 may represent a wireless transceiver and may communicate bi-directionally with another wireless transceiver. The transceiver 1615 may also include a modem to modulate the packets and provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include RAM and ROM. The memory 1630 may store computer-readable, computer-executable, or processor-executable code, such as code 1635. The code 1635 may include instructions that, when executed by the processor 1640, cause the device 1605 to perform various functions described herein. In some cases, the memory 1630 may include, among other things, a BIOS which may control basic hardware or software operation such as the interaction with peripheral components or devices.

The processor 1640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting traffic estimation and wireless actions based on wireless traffic ingress rates). For example, the device 1605 or a component of the device 1605 may include a processor 1640 and memory 1630 coupled to the processor 1640, the processor 1640 and memory 1630 configured to perform various functions described herein.

The inter-station communications manager 1645 may manage communications with other APs 105, and may include a controller or scheduler for controlling communications with STAs 115 in cooperation with other APs 105. For example, the inter-station communications manager 1645 may coordinate scheduling for transmissions to APs 105 for various interference mitigation techniques such as beamforming or joint transmission. In some examples, the inter-station communications manager 1645 may provide an X2 interface within an LTE/LTE-A wireless communication network technology to provide communication between APs 105.

The communications manager 1620 may support wireless communication in accordance with examples as disclosed herein. For example, the communications manager 1620 is capable of, configured to, or operable to support a means for detecting that an ingress rate of data of a first wireless communication session associated with a wireless node satisfies an ingress rate threshold. The communications manager 1620 is capable of, configured to, or operable to support a means for updating a scheduling priority of the first wireless communication session to be different than a scheduling priority of a second wireless communication session, the update being based on the ingress rate satisfying the ingress rate threshold.

By including or configuring the communications manager 1620 in accordance with examples as described herein, the device 1605 may support techniques for reducing the throughput of a wireless node, a wireless communication session, or both to support improved communication reliability, reduced latency, improved user experience related to reduced processing, reduced power consumption, more efficient utilization of communication resources, improved coordination between devices, longer battery life, and improved utilization of processing capability.

FIG. 17 shows a flowchart illustrating an example process 1700 performable by or at an apparatus for wireless communication that supports traffic estimation and wireless actions based on wireless traffic ingress rates. The operations of the process 1700 may be implemented at an apparatus for wireless communication or its components as described herein. For example, the process 1700 may be performed by a wireless communication device, such as the wireless communication device 1100 described with reference to FIG. 11, operating as or within a wireless AP. In some examples, the process 1700 may be performed by a wireless AP, such as one of the APs 102 described with reference to FIG. 1.

In some examples, in 1705, the apparatus for wireless communication may detect that an ingress rate of data of a first wireless communication session associated with a wireless node satisfies an ingress rate threshold. The operations of 1705 may be performed in accordance with examples as disclosed herein. In some implementations, aspects of the operations of 1705 may be performed by an ingress rate detection component 1125 as described with reference to FIG. 11.

In some examples, in 1710, the apparatus for wireless communication may adjust a set of communication parameters associated with the wireless node for subsequent communications based on the ingress rate satisfying the ingress rate threshold. The operations of 1710 may be performed in accordance with examples as disclosed herein. In some implementations, aspects of the operations of 1710 may be performed by a communication parameter adjustment component 1130 as described with reference to FIG. 11.

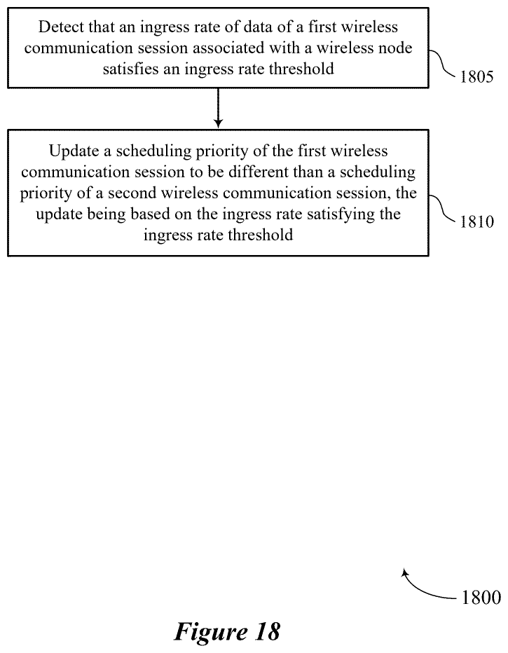

FIG. 18 shows a flowchart illustrating a method 1800 that supports traffic estimation and wireless actions based on wireless traffic ingress rates in accordance with one or more aspects of the present disclosure. The operations of the method 1800 may be implemented at an AP or its components as described herein. For example, the operations of the method 1800 may be performed at an AP as described with reference to FIGS. 2 through 8 and 13 through 16. In some examples, an AP may execute a set of instructions to control the functional elements of the AP to perform the described functions. Additionally, or alternatively, the AP may perform aspects of the described functions using special-purpose hardware.

At 1805, the method may include detecting that an ingress rate of data of a first wireless communication session associated with a wireless node satisfies an ingress rate threshold. The operations of 1805 may be performed in accordance with examples as disclosed herein. In some examples, aspects of the operations of 1805 may be performed by an ingress rate detection component 1525 as described with reference to FIG. 15.

At 1810, the method may include updating a scheduling priority of the first wireless communication session to be different than a scheduling priority of a second wireless communication session, the update being based on the ingress rate satisfying the ingress rate threshold. The operations of 1810 may be performed in accordance with examples as disclosed herein. In some examples, aspects of the operations of 1810 may be performed by a scheduling priority update component 1530 as described with reference to FIG. 15. Implementation examples are described in the following numbered clauses:

The following provides an overview of aspects of the present disclosure:

Aspect 1: A method for wireless communication at a wireless node, comprising: detecting that an ingress rate of data of a first wireless communication session associated with a second wireless node satisfies an ingress rate threshold; and adjusting a set of communication parameters associated with the wireless node for subsequent communications based at least in part on the ingress rate satisfying the ingress rate threshold.

Aspect 2: The method of aspect 1, wherein adjusting the set of communication parameters further comprises: moving the subsequent communications from a first wireless communication link to a second wireless communication link with a capacity higher than a capacity of the first wireless communication link.

Aspect 3: The method of any of aspects 1 through 2, wherein adjusting the set of communication parameters further comprises: allocating a plurality of additional wireless communication links to the wireless node for the subsequent communications.

Aspect 4: The method of any of aspects 1 through 3, wherein detecting that the ingress rate of data satisfies the ingress rate threshold further comprises: detecting that the first wireless communication session satisfies at least one of a first ingress rate value threshold associated with the wireless node, a first ingress rate delta threshold associated with the wireless node, a second ingress rate value threshold associated with the first wireless communication session, or a second ingress rate delta threshold associated with the first wireless communication session.

Aspect 5: The method of any of aspects 1 through 4, further comprising: detecting that the ingress rate of the first wireless communication session ceases to satisfy the ingress rate threshold; and adjusting the set of communication parameters of the wireless node based on the ingress rate ceasing to satisfy the ingress rate threshold.

Aspect 6: The method of aspect 5, further comprising: detecting that the ingress rate ceases from satisfying the ingress rate threshold for each time interval of a plurality of time intervals.

Aspect 7: The method of any of aspects 1 through 6, further comprising: updating a scheduling priority of the first wireless communication session to be different than a scheduling priority of a second wireless communication session associated with the wireless node based on the ingress rate satisfying the ingress rate threshold.

Aspect 8: The method of aspect 7, wherein at least one of the adjustment or the update is based on one or more of a plurality of procedures associated with the detection.

Aspect 9: The method of any of aspects 1 through 8, wherein the first wireless communication session comprises one or more data traffic flows, each data traffic flow being associated with a same source internet protocol (IP) address and a same destination IP address.

Aspect 10: The method of aspect 9, wherein the one or more data traffic flows are further associated with at least one of a source port, a destination port, a communication protocol, a source medium access control (MAC) address, or a destination MAC address; or the wireless node is associated with the destination MAC address.

Aspect 11: The method of any of aspects 1 through 10, further comprising: allocating a plurality of additional wireless communication links to the wireless node in accordance with a multi-link operation framework.

Aspect 12: The method of any of aspects 1 through 11, wherein the detection is based on at least one of a periodic ingress rate database, a set of quality algorithms, a host, or a scheduler.

Aspect 13: A method for wireless communication at a wireless node, comprising: detecting that an ingress rate of data of a first wireless communication session associated with a second wireless node satisfies an ingress rate threshold; and updating a scheduling priority of the first wireless communication session to be different than a scheduling priority of a second wireless communication session, the update being based at least in part on the ingress rate satisfying the ingress rate threshold.

Aspect 14: The method of aspect 13, further comprising: detecting that the first wireless communication session satisfies at least one of a first ingress rate value threshold associated with the wireless node, a first ingress rate delta threshold associated with the wireless node, a second ingress rate value threshold associated with the first wireless communication session, or a second ingress rate delta threshold associated with the first wireless communication session.

Aspect 15: The method of any of aspects 13 through 14, further comprising: detecting that the ingress rate of the first wireless communication session ceases to satisfy the ingress rate threshold; and updating the scheduling priority of the first wireless communication session to be different than the scheduling priority of the second wireless communication session based on the first wireless communication session ceases to satisfy the ingress rate threshold.

Aspect 16: The method of aspect 15, wherein detect that the ingress rate ceases to satisfy the ingress rate threshold for each time interval of a plurality of time interval.

Aspect 17: The method of any of aspects 13 through 16, wherein updating the scheduling priority of the first wireless communication session to be different than the scheduling priority of the second wireless communication session comprises updating the scheduling priority of the first wireless communication session to be higher than the scheduling priority of the second wireless communication session.

Aspect 18: The method of any of aspects 13 through 17, wherein updating the scheduling priority of the first wireless communication session further comprises updating a scheduling priority of one or more data traffic flows associated with the first wireless communication session.

Aspect 19: The method of any of aspects 13 through 18, wherein the apparatus updates the scheduling priority of the first wireless communication session in accordance with a service based scheduling framework.

Aspect 20: A wireless node, including at least one transceiver and a processing system that includes processor circuitry and memory circuitry that stores code, the processing system configured to cause the wireless node to perform the method of any of aspects 1-12, wherein the at least one transceiver is configured to communicate with another wireless node via the set of communication parameters.

Aspect 21: An apparatus for wireless communication, including a processing system that includes processor circuitry and memory circuitry that stores code, the processing system configured to cause the apparatus to perform the method of any of aspects 1 through 12.

Aspect 22: An apparatus for wireless communication, comprising at least one means for performing a method of any of aspects 1 through 12.

Aspect 23: A non-transitory computer-readable medium storing code for wireless communication, the code comprising instructions executable by one or more processors to perform a method of any of aspects 1 through 12.

Aspect 24: A wireless node, including at least one transceiver, and a processing system that includes processor circuitry and memory circuitry that stores code, the processing system configured to cause the wireless node to perform the method of any of aspects 13-19, wherein the at least one transceiver is configured to communicate with another wireless node according to the priority.

Aspect 25: An apparatus for wireless communication, including a processing system that includes processor circuitry and memory circuitry that stores code, the processing system configured to cause the apparatus to perform the method of any of aspects 13 through 19.

Aspect 26: An apparatus for wireless communication, comprising at least one means for performing a method of any of aspects 13 through 19.

Aspect 27: A non-transitory computer-readable medium storing code for wireless communication, the code comprising instructions executable by one or more processors to perform a method of any of aspects 13 through 19.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
a processing system that includes processor circuitry and memory circuitry that stores code, the processing system configured to cause the apparatus to:
detect that an ingress rate of data of a first wireless communication session associated with a wireless node satisfies an ingress rate threshold; and
adjust a set of communication parameters associated with the wireless node for subsequent communications based at least in part on the ingress rate satisfying the ingress rate threshold.

2. The apparatus of claim 1, wherein, to adjust the set of communication parameters, the processing system is further configured to cause the apparatus to:
move the subsequent communications from a first wireless communication link to a second wireless communication link with a capacity higher than a capacity of the first wireless communication link.

3. The apparatus of claim 1, wherein, to adjust the set of communication parameters, the processing system is further configured to cause the apparatus to:
allocate a plurality of additional wireless communication links to the wireless node for the subsequent communications.

4. The apparatus of claim 1, wherein, to detect that the ingress rate of data satisfies the ingress rate threshold, the processing system is further configured to cause the apparatus to:
detect that the first wireless communication session satisfies at least one of a first ingress rate value threshold associated with the wireless node, a first ingress rate delta threshold associated with the wireless node, a second ingress rate value threshold associated with the first wireless communication session, or a second ingress rate delta threshold associated with the first wireless communication session.

5. The apparatus of claim 1, wherein the processing system is further configured to cause the apparatus to:
detect that the ingress rate of the first wireless communication session ceases to satisfy the ingress rate threshold; and
adjust the set of communication parameters of the wireless node based on the ingress rate ceasing to satisfy the ingress rate threshold.

6. The apparatus of claim 5, wherein detecting that the first wireless communication session ceases to satisfy the ingress rate threshold, the processing system is configured to:
detect that the ingress rate ceases from satisfying the ingress rate threshold for each time interval of a plurality of time intervals.

7. The apparatus of claim 1, wherein the processing system is further configured to cause the apparatus to:
update a scheduling priority of the first wireless communication session to be different than a scheduling priority of a second wireless communication session associated with the wireless node based on the ingress rate satisfying the ingress rate threshold.

8. The apparatus of claim 7, wherein at least one of the adjustment or the update is based on one or more of a plurality of procedures associated with the detection.

9. The apparatus of claim 1, wherein the first wireless communication session comprises one or more data traffic flows, each data traffic flow being associated with a same source internet protocol (IP) address and a same destination IP address.

10. The apparatus of claim 9, wherein at least one of:
the one or more data traffic flows are further associated with at least one of a source port, a destination port, a communication protocol, a source medium access control (MAC) address, or a destination MAC address; or
the wireless node is associated with the destination MAC address.

11. The apparatus of claim 1, wherein the processing system is further configured to cause the apparatus to:
allocate a plurality of additional wireless communication links to the wireless node in accordance with a multi-link operation framework.

12. The apparatus of claim 1, wherein the detection is based on at least one of a periodic ingress rate database, a set of quality algorithms, a host, or a scheduler.

13. The apparatus of claim 1, further comprising one or more antennas configured to communicate with the wireless node via the set of communication parameters, wherein the apparatus configured as an access point (AP).

14. An apparatus for wireless communication, comprising:
a processing system that includes processor circuitry and memory circuitry that stores code, the processing system configured to cause the apparatus to:
detect that an ingress rate of data of a first wireless communication session associated with a wireless node satisfies an ingress rate threshold; and
updating a scheduling priority of the first wireless communication session to be different than a scheduling priority of a second wireless communication session, the update being based at least in part on the ingress rate satisfying the ingress rate threshold.

15. The apparatus of claim 14, wherein the processing system is further configured to cause the apparatus to:
detect that the first wireless communication session satisfies at least one of a first ingress rate value threshold associated with the wireless node, a first ingress rate delta threshold associated with the wireless node, a second ingress rate value threshold associated with the first wireless communication session, or a second ingress rate delta threshold associated with the first wireless communication session.

16. The apparatus of claim 14, wherein the processing system is further configured to cause the apparatus to:
detect that the ingress rate of the first wireless communication session ceases to satisfy the ingress rate threshold; and
update the scheduling priority of the first wireless communication session to be different than the scheduling priority of the second wireless communication session based on the first wireless communication session ceases to satisfy the ingress rate threshold.

17. The apparatus of claim 14, wherein updating the scheduling priority of the first wireless communication session to be different than the scheduling priority of the second wireless communication session comprises updating the scheduling priority of the first wireless communication session to be higher than the scheduling priority of the second wireless communication session.

18. The apparatus of claim 14, wherein updating the scheduling priority of the first wireless communication session further comprises updating a scheduling priority of one or more data traffic flows associated with the first wireless communication session.

19. The apparatus of claim 14, wherein the apparatus updates the priority of the first wireless communication session in accordance with a service based scheduling framework.

20. The apparatus of claim 14, further comprising one or more antennas configured to communicate with the wireless node according to the priority, wherein the apparatus configured as an access point (AP).
